(19) United States
(12) Patent Application Publication
(10) Pub. No.: US 2018/0015362 A1
(43) Pub. Date: Jan. 18, 2018

(54) INFORMATION PROCESSING METHOD AND PROGRAM FOR EXECUTING THE INFORMATION PROCESSING METHOD ON COMPUTER

(71) Applicant: COLOPL, Inc., Tokyo (JP)

(72) Inventor: Shuhei TERAHATA, Tokyo (JP)

(21) Appl. No.: 15/647,396

(22) Filed: Jul. 12, 2017

(30) Foreign Application Priority Data
Jul. 13, 2016 (JP) 2016-138832
Jul. 13, 2016 (JP) 2016-138833

(51) Int. Cl. A63F 13/21; G06F 3/16; G06F 3/01; G06F 17/30

(52) U.S. Cl. CPC A63F 13/21; G06F 17/30056; G06F 3/167; G06F 3/017; A63F 2300/632; A63F 2300/6045; A63F 2300/1087

(57) ABSTRACT

An information processing method including generating virtual space data for defining a virtual space comprising a virtual camera and a sound source object. The virtual space includes first and second regions. The method further includes determining a visual field of the virtual camera in accordance with a detected movement of a first head mounted display (HMD). The method further includes generating visual-field image data based on the visual field of the virtual camera and the virtual space data. The method further includes instructing the first HMD to display a visual-field image based on the visual-field image data. The method further includes setting an attenuation coefficient for defining an attenuation amount of a sound propagating through the virtual space, wherein the attenuation coefficient is set based on a the visual field of the virtual camera. The method further includes processing the sound based on the attenuation coefficient.

### RELATED APPLICATIONS

The present application claims priority to Japanese Patent Applications Nos. 2016-138832 and 2016-138833 filed Jul. 13, 2016, the disclosures of which is hereby incorporated by reference herein in its entirety.

### TECHNICAL FIELD

This disclosure relates to an information processing method and a program for executing the information processing method on a computer.

### BACKGROUND ART

In Patent Document 1, there is disclosed processing (sound localization processing) of calculating, when a mobile body serving as a perspective in a game space or a sound source has moved during execution of a game program, a relative positional relationship between the mobile body and the sound source, and processing a sound to be output from the sound source by using a localization parameter based on the calculated relative positional relationship.

### PATENT DOCUMENTS

[Patent Document 1] JP 2007-050267 A

### SUMMARY

Patent Document 1 does not describe conferring directivity on the sound to be output from an object defined as the sound source in a virtual space (virtual reality (VR) space).

This disclosure helps to provide an information processing method and a system for executing the information processing method, which confer directivity on a sound to be output from an object defined as a sound source in a virtual space.

According to at least one embodiment of this disclosure, an information processing method for use in a system including a first user terminal including a first head-mounted display and a sound inputting unit.

The information processing method includes generating virtual space data for defining a virtual space including a virtual camera and a sound source object defined as a sound source of a sound that has been input to the sound inputting unit. The method further includes determining a visual field of the virtual camera in accordance with a movement of the first head-mounted display. The method further includes generating visual-field image data based on the visual field of the virtual camera and the virtual space data. The method further includes causing the first head-mounted display to display a visual-field image based on the visual-field image data. The method further includes setting, for a first region of the virtual space, an attenuation coefficient for defining an attenuation amount per unit distance of a sound propagating through the virtual space to a first attenuation coefficient, and for a second region of the virtual space different from the first region, the attenuation coefficient to a second attenuation coefficient.

The first attenuation coefficient and the second attenuation coefficient are different from each other.

### Effects

According to at least one embodiment of this disclosure, the information processing method conferring directivity on a sound to be output from an object defined as a sound source in a virtual space is possible. Further, a system for executing the information processing method on a computer is possible.

### BRIEF DESCRIPTION OF THE DRAWINGS

FIG. 1 A schematic diagram of a configuration of a game system according to at least one embodiment of this disclosure.

FIG. 2 A schematic diagram of a head-mounted display (HMD) system of the game system according to at least one embodiment of this disclosure.

FIG. 3 A diagram of a head of a user wearing an HMD according to at least one embodiment of this disclosure.

FIG. 4 A diagram of a hardware configuration of a control device according to at least one embodiment of this disclosure.

FIG. 5 A flowchart of a method of displaying a visual-field image on the HMD according to at least one embodiment of this disclosure.

FIG. 6 An xyz spatial diagram of a virtual space according to at least one embodiment of this disclosure.

FIG. 7A A yx plane diagram of the virtual space according to at least one embodiment of this disclosure.

FIG. 7B A zx plane diagram of the virtual space according to at least one embodiment of this disclosure.

FIG. 8 A diagram of a visual-field image displayed on the HMD according to at least one embodiment of this disclosure.

FIG. 9 A flowchart of an information processing method according to a at least one embodiment of this disclosure.

FIG. 10 A diagram including a friend avatar object positioned in a visual field of a virtual camera and an enemy avatar object positioned outside the visual field of the virtual camera, which is exhibited when the virtual camera and a sound source object are integrally constructed according to at least one embodiment of this disclosure.

FIG. 11 A diagram including a self avatar object and a friend avatar object positioned in the visual field of the virtual camera and an enemy avatar object positioned outside the visual field of the virtual camera, which is exhibited when the self avatar object and the sound source object are integrally constructed according to at least one embodiment of this disclosure.

FIG. 12 A flowchart of an information processing method according to at least one embodiment of this disclosure.

FIG. 13 A diagram including a friend avatar object positioned in an eye gaze region and an enemy avatar object positioned in a visual field of the virtual camera other than the eye gaze region, which is exhibited when the virtual camera and the sound source object are integrally constructed according to at least one embodiment.

FIG. 14 A flowchart of an information processing method according to at least one embodiment of this disclosure.

FIG. 15 A diagram including a friend avatar object positioned in a visual axis region and an enemy avatar object positioned in a visual field of the virtual camera other than the visual axis region, which is exhibited when the virtual camera and the sound source object are integrally constructed according to at least one embodiment of this disclosure.

FIG. 16 A flowchart of an information processing method according to at least one embodiment of this disclosure.

FIG. 17 A diagram including a friend avatar object and a self avatar object positioned on an inner side (of an attenuation object and an enemy avatar object positioned on an outer side of the attenuation object, which is exhibited when the self avatar object and the sound source object are integrally constructed according to at least one embodiment of this disclosure.

FIG. 18 A flowchart of an information processing method according to at least one embodiment of this disclosure.

FIG. 19 A flowchart of an information processing method according to at least one embodiment of this disclosure.

FIG. 20 A diagram including a friend avatar object positioned on the inner side of the attenuation object and an enemy avatar object positioned on the outer side of the attenuation object, which is exhibited when the virtual camera and the sound source object are integrally constructed according to at least one embodiment of this disclosure.

FIG. 21 A diagram of a virtual space exhibited before a sound reflecting object is generated according to at least one embodiment of this disclosure.

FIG. 22 A flowchart of an information processing method according to at least one embodiment of this disclosure.

FIG. 23 A diagram of a virtual space including the sound reflecting object according to at least one embodiment of this disclosure.

### DETAILED DESCRIPTION

Now, a description is given of an outline of some embodiments according to this disclosure.

(1) An information processing method for use in a system including a first user terminal including a first head-mounted display and a sound inputting unit. The information processing method includes generating virtual space data for defining a virtual space including a virtual camera and a sound source object defined as a sound source of a sound that has been input to the sound inputting unit. The method further includes determining a visual field of the virtual camera in accordance with a movement of the first head-mounted display. The method further includes generating visual-field image data based on the visual field of the virtual camera and the virtual space data. The method further includes causing the first head-mounted display to display a visual-field image based on the visual-field image data. The method further includes setting, for a first region of the virtual space, an attenuation coefficient for defining an attenuation amount per unit distance of a sound propagating through the virtual space to a first attenuation coefficient, and for a second region of the virtual space different from the first region, the attenuation coefficient to a second attenuation coefficient. The first attenuation coefficient and the second attenuation coefficient being different from each other.

According to the above-mentioned method, the attenuation coefficient is set to the first attenuation coefficient for the first region of the virtual space, and the attenuation coefficient is set to the second attenuation coefficient, which is different from the first attenuation coefficient, for the second region of the virtual space. Because different attenuation coefficients are thus set for each of the first and second regions, directivity can be conferred on the sound to be output from the sound source object in the virtual space.

(2) An information processing method according to Item (1), in which the system further includes a second user terminal including a second head-mounted display and a second sound outputting unit. The virtual space further includes an avatar object associated with the second user terminal. The method further includes acquiring sound data representing a sound that has been input to the sound inputting unit. The method further includes specifying a relative positional relationship between the sound source object and the avatar object. The method further includes judging whether or not the avatar object is positioned in the first region of the virtual space. The method further includes processing the sound data based on the specified relative positional relationship and the attenuation coefficient. The method further includes causing the sound outputting unit to output a sound corresponding to the processed sound data. In response to the second avatar object being judged to be positioned in the first region, the attenuation coefficient is set to the first attenuation coefficient, and then the sound data is processed based on the relative positional relationship and the first attenuation coefficient. In response to the avatar object being judged to be positioned in the second region, the attenuation coefficient is set to the second attenuation coefficient, and then the sound data is processed based on the relative positional relationship and the second attenuation coefficient.

According to the above-mentioned method, when the avatar object is judged to be positioned in the first region, the attenuation coefficient is set to the first attenuation coefficient, and then the sound data is processed based on the relative positional relationship and the first attenuation coefficient. On the other hand, when the avatar object is judged to be positioned in the second region, the attenuation coefficient is set to the second attenuation coefficient, and then the sound data is processed based on the relative positional relationship and the second attenuation coefficient.

In this way, the volume (i.e., sound pressure level) of the sound to be output from the sound outputting unit is different depending on the position of the avatar object on the virtual space. For example, when the first attenuation coefficient is smaller than the second attenuation coefficient, the volume of the sound to be output from the sound outputting unit when the avatar object is present in the first region is larger than the volume of the sound to be output from the sound outputting unit when the avatar object is present in the second region. As a result, when the friend avatar object is present in the first region and the enemy avatar object is present in the second region, the user of the first user terminal can issue a sound-based instruction to the user operating the friend avatar object without the user operating the enemy avatar object noticing. Therefore, the entertainment value of the virtual space can be improved.

(3) An information processing method according to Item (1) or (2), in which the first region is in the visual field of the virtual camera and the second region is outside the visual field of the virtual camera.

According to the above-mentioned method, when the avatar object is judged to be positioned in the visual field, the attenuation coefficient is set to the first attenuation coefficient, and then the sound data is processed based on the relative positional relationship and the first attenuation coefficient. On the other hand, when the avatar object is judged to be positioned outside the visual field, the attenuation coefficient is set to the second attenuation coefficient, and then the sound data is processed based on the relative positional relationship and the second attenuation coefficient.

In this way, the volume (i.e., sound pressure level) of the sound to be output from the sound outputting unit is different depending on the position of the avatar object on the virtual space. For example, when the first attenuation coefficient is smaller than the second attenuation coefficient, the volume of the sound to be output from the sound outputting unit when the avatar object is present in the visual field is larger than the volume of the sound to be output from the sound outputting unit when the avatar object is present outside the visual field. As a result, when the friend avatar object is present in the visual field and the enemy avatar object is present outside the visual field, the user of the first user terminal can issue a sound-based instruction to the user operating the friend avatar object without the user operating the enemy avatar object noticing. Therefore, the entertainment value of the virtual space can be improved.

(4) An information processing method according to Item (1) or (2), in which the first region is an eye gaze region defined by a line-of-sight direction of a user wearing the first head-mounted display and the second region is in the visual field of the virtual camera other than the eye gaze region.

According to the above-mentioned method, when the avatar object is judged to be positioned in the eye gaze region, the attenuation coefficient is set to the first attenuation coefficient, and then the sound data is processed based on the relative positional relationship and the first attenuation coefficient. On the other hand, when the avatar object is judged to be positioned in the visual field of the virtual camera other than the eye gaze region (hereinafter simply referred to as “outside the eye gaze region”), the attenuation coefficient is set to the second attenuation coefficient, and then the sound data is processed based on the relative positional relationship and the second attenuation coefficient.

In this way, the volume (i.e., sound pressure level) of the sound to be output from the sound outputting unit is different depending on the position of the avatar object on the virtual space. For example, when the first attenuation coefficient is smaller than the second attenuation coefficient, the volume of the sound to be output from the sound outputting unit when the avatar object is present in the eye gaze region is larger than the volume of the sound to be output from the sound outputting unit when the avatar object is present outside the eye gaze region. As a result, when the friend avatar object is present in the eye gaze region and the enemy avatar object is present outside the eye gaze region, the user of the first user terminal can issue a sound-based instruction to the user operating the friend avatar object without the user operating the enemy avatar object noticing. Therefore, the entertainment value of the virtual space can be improved.

(5) An information processing method according to Item (1) or (2), in which the first region is a visual axis region defined by a visual axis of the virtual camera and the second region is in the visual field of the virtual camera other than the visual axis region.

According to the above-mentioned method, when the avatar object is judged to be positioned in the visual axis region, the attenuation coefficient is set to the first attenuation coefficient, and then the sound data is processed based on the relative positional relationship and the first attenuation coefficient. On the other hand, when the avatar object is judged to be positioned in the visual field of the virtual camera other than the visual axis region (hereinafter simply referred to as “outside the visual axis region”), the attenuation coefficient is set to the second attenuation coefficient, and then the sound data is processed based on the relative positional relationship and the second attenuation coefficient.

In this way, the volume (i.e., sound pressure level) of the sound to be output from the sound outputting unit is different depending on the position of the avatar object on the virtual space. For example, when the first attenuation coefficient is smaller than the second attenuation coefficient, the volume of the sound to be output from the sound outputting unit when the avatar object is present in the visual axis region is larger than the volume of the sound to be output from the sound outputting unit when the avatar object is present outside the visual axis region. As a result, when the friend avatar object is present in the visual axis region and the enemy avatar object is present outside the visual axis region, the user of the first user terminal can issue a sound-based instruction to the user operating the friend avatar object without the user operating the enemy avatar object noticing. Therefore, the entertainment value of the virtual space can be improved.

(6) An information processing method for use in a system including a first user terminal including a first head-mounted display and a sound inputting unit. The method information processing includes generating virtual space data for defining a virtual space including a virtual camera and a sound source object defined as a sound source of a sound that has been input to the sound inputting unit. The method further includes determining a visual field of the virtual camera in accordance with a movement of the first head-mounted display. The method further includes generating visual-field image data based on the visual field of the virtual camera and the virtual space data. The method further includes causing the first head-mounted display to display a visual-field image based on the visual-field image data. The virtual space further includes an attenuation object for defining an attenuation amount of a sound propagating through the virtual space. The attenuation object is arranged on a boundary between the first region and the second region of the virtual space.

According to the above-mentioned method, the attenuation object for defining the attenuation amount of a sound propagating through the virtual space is arranged on the boundary between the first region and the second region of the virtual space. Therefore, for example, the attenuation amount of the sound to be output from the sound source object defined as the sound source is different for each of the first region and the second region of the virtual space. As a result, directivity can be conferred on the sound to be output from the sound source object in the virtual space.

(7) An information processing method according to Item (6), in which the attenuation object is transparent or inhibited from being displayed in the visual-field image.

According to the above-mentioned method, because the attenuation object is inhibited from being displayed in the visual-field image, directivity can be conferred on the sound that has been output from the sound source object without harming the sense of immersion of the user in the virtual space (i.e., sense of being present in the virtual space).

(8) An information processing method according to Item (6) or (7), in which the sound source object is arranged in the first region of the virtual space.

According to the above-mentioned method, the sound source object is arranged in the first region of the virtual space. Therefore, in the second region of the virtual space, the sound to be output from the sound source object is further attenuated than in the first region of the virtual space by an attenuation amount defined by the attenuation object. As a result, directivity can be conferred on the sound to be output from the sound source object.

(9) An information processing method according to Item (8), in which the system further includes a second user terminal including a second head-mounted display and a sound outputting unit. The virtual space further includes an avatar object associated with the second user terminal. The method further includes acquiring sound data representing a sound that has been input to the sound inputting unit. The method further includes specifying a relative positional relationship between the sound source object and the avatar object. The method further includes judging whether or not the avatar object is positioned in the first region of the virtual space. The method further includes processing the sound data. The method further includes causing the sound outputting unit to output a sound corresponding to the processed sound data. when the avatar object is judged to be positioned in the first region of the virtual space, the sound data is processed based on the relative positional relationship. When the avatar object is judged to be positioned in the second region of the virtual space, the sound data is processed based on the relative positional relationship and an attenuation amount defined by the attenuation object.

According to the above-mentioned method, when an avatar object is judged to be positioned in the first region of the virtual space in which the sound source is positioned, the sound data is processed based on the relative positional relationship. On the other hand, when the avatar object is judged to be positioned in the second region of the virtual space, the sound data is processed based on the relative positional relationship and the attenuation amount defined by the attenuation object.

In this way, the volume (i.e., sound pressure level) of the sound to be output from the sound outputting unit is different depending on the position of the avatar object on the virtual space. The volume of the sound to be output from the sound outputting unit when the avatar object is present in the first region of the virtual space is larger than the volume of the sound to be output from the sound outputting unit when the avatar object is present in the second region of the virtual space. As a result, when the friend avatar object is present in the first region of the virtual space and the enemy avatar object is present in the second region of the virtual space, the user of the first user terminal can issue a sound-based instruction to the user operating the friend avatar object without the user operating the enemy avatar object noticing. Therefore, the entertainment value of the virtual space can be improved.

(10) An information processing method according to Item (8) or (9), in which the first region is in the visual field of the virtual camera and the second region is outside the visual field of the virtual camera.

According to the above-mentioned method, the sound source object is arranged in the visual field of the virtual camera and the attenuation object is arranged on a boundary of the visual field of the virtual camera. Therefore, outside the visual field of the virtual camera, the sound to be output from the sound outputting unit is further attenuated than in the visual field of the virtual camera by an attenuation amount defined by the attenuation object. As a result, directivity can be conferred on the sound to be output from the sound source object in the virtual space.

(11) A system for executing the information processing method of any one of Items (1) to (10).

Therefore, there can be provided a system capable of conferring directivity on the sound to be output from the sound source object defined as a sound source in the virtual space.

Embodiments of this disclosure are described below with reference to the drawings. Once a component is described in this description of embodiments, a description on a component having the same reference number as that of the already described component is omitted for the sake of convenience.

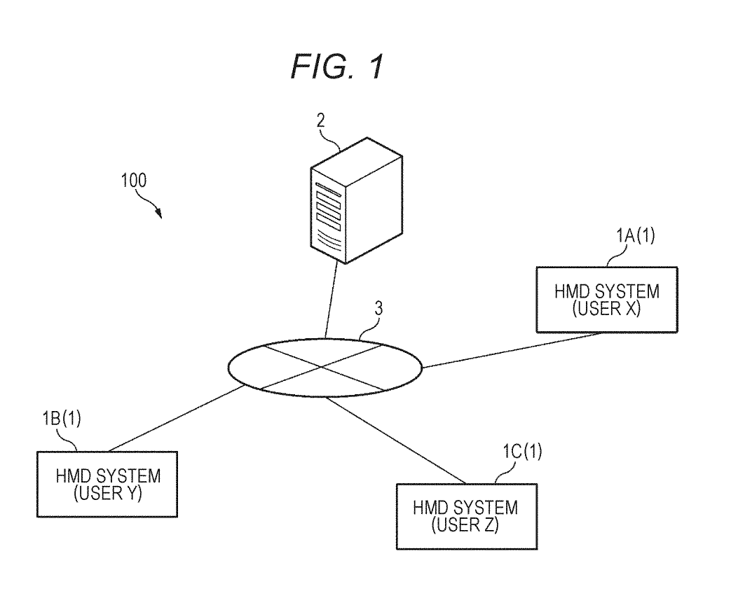

A configuration of a game system 100 configured to implement an information processing method according to at least one embodiment of this disclosure (hereinafter simply referred to as “this embodiment”) is described with reference to FIG. 1. FIG. 1 is a schematic diagram of a configuration of the game system 100 according to at least one embodiment of this disclosure. In FIG. 1, the HMD system 1 includes a head-mounted display (hereinafter simply referred to as “HMD”) system 1A (non-limiting example of first user terminal) to be operated by a user X, an HMD system 1B (non-limiting example of second user terminal) to be operated by a user Y, an HMD system 1C (non-limiting example of third user terminal) to be operated by a user Z, and a game server 2 configured to control the HMD systems 1A to 1C in synchronization. The HMD systems A1, 1B, and 1C and the game server 2 are connected to each other via a communication network 3, for example, the Internet so as to enable communication therebetween. In at least one embodiment, a client server system is constructed of the HMD systems 1A to 1C and the game server 2, but the HMD system 1A, the HMD system 1B, and the HMD system 1C may be configured to directly communicate to and from each other (by P2P) without the game server 2 being included. For the sake of convenience in description, the HMD systems 1A, 1B, and 1C may simply be referred to as “HMD system 1”. The HMD systems 1A, 1B, and 1C have the same configuration.

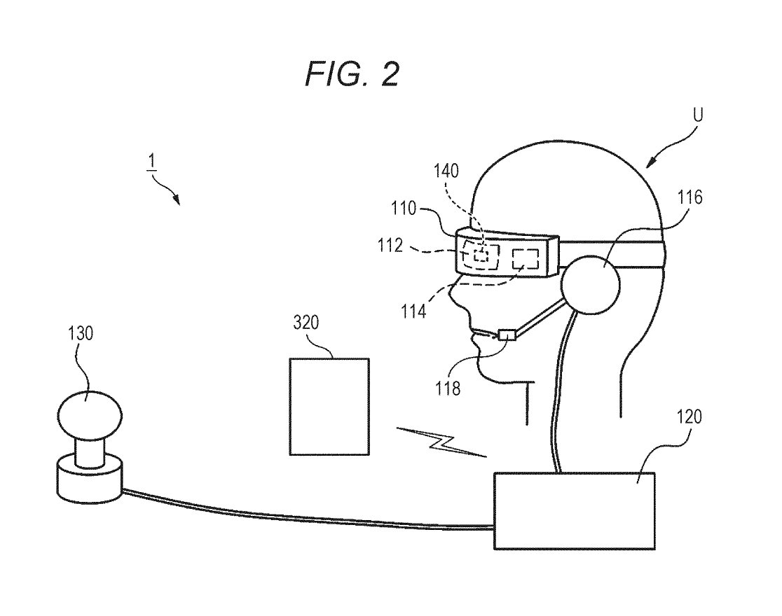

Next, the configuration of the HMD system 1 is described with reference to FIG. 2. FIG. 2 is a schematic diagram of the HMD system 1 according to at least one embodiment of this disclosure. In FIG. 2, the HMD system 1 includes an HMD 110 worn on the head of a user U, headphones 116 (non-limiting example of sound outputting unit) worn on both ears of the user U, a microphone 118 (non-limiting example of sound inputting unit) positioned in a vicinity of the mouth of the user U, a position sensor 130, an external controller 320, and a control device 120.

The HMD 110 includes a display unit 112, an HMD sensor 114, and an eye gaze sensor 140. The display unit 112 includes a non-transmissive display device configured to completely cover a field of view (visual field) of the user U wearing the HMD 110. In at least one embodiment, the display unit 112 includes a partially-transmissive display device. With this, the user U can see only a visual-field image displayed on the display unit 112, and hence the user U can be immersed in a virtual space. The display unit 112 may include a left-eye display unit configured to provide an image to a left eye of the user U, and a right-eye display unit configured to provide an image to a right eye of the user U.

The HMD sensor 114 is mounted near the display unit 112 of the HMD 110. The HMD sensor 114 includes at least one of a geomagnetic sensor, an acceleration sensor, and an inclination sensor (for example, an angular velocity sensor or a gyro sensor), and can detect various movements of the HMD 110 worn on the head of the user U.

The eye gaze sensor 140 has an eye tracking function of detecting a line-of-sight direction of the user U. For example, the eye gaze sensor 140 may include a right-eye gaze sensor and a left-eye gaze sensor. The right-eye gaze sensor may be configured to detect reflective light reflected from the right eye (in particular, the cornea or the iris) of the user U by irradiating the right eye with, for example, infrared light, to thereby acquire information relating to a rotational angle of a right eyeball. Meanwhile, the left-eye gaze sensor may be configured to detect reflective light reflected from the left eye (in particular, the cornea or the iris) of the user U by irradiating the left eye with, for example, infrared light, to thereby acquire information relating to a rotational angle of a left eyeball.

The headphones 116 are worn on right and left ears of the user U. The headphones 116 are configured to receive sound data (electrical signal) from the control device 120 to output sounds based on the received sound data. The sound to be output to a right-ear speaker of the headphones 116 may be different from the sound to be output to a left-ear speaker of the headphones 116. For example, the control device 120 may be configured to obtain sound data to be input to the right-ear speaker and sound data to be input to the left-ear speaker based on a head-related transfer function, to thereby output those two different pieces of sound data to the left-ear speaker and the right-ear speaker of the headphones 116, respectively. In at least one embodiment, the sound outputting unit includes plurality of independent stationary speakers, at least one speaker is attached to HMD 110, or earphones may be provided.

The microphone 118 is configured to collect sounds uttered by the user U, and to generate sound data (i.e., electric signal) based on the collected sounds. The microphone 118 is also configured to transmit the sound data to the control device 120. The microphone 118 may have a function of converting the sound data from analog to digital (AD conversion). The microphone 118 may be physically connected to the headphones 116. The control device 120 may be configured to process the received sound data, and to transmit the processed sound data to another HMD system via the communication network 3.

The position sensor 130 is constructed of, for example, a position tracking camera, and is configured to detect the positions of the HMD 110 and the external controller 320. The position sensor 130 is connected to the control device 120 so as to enable communication to/from the control device 120 in a wireless or wired manner. The position sensor 130 is configured to detect information relating to positions, inclinations, or light emitting intensities of a plurality of detection points (not shown) provided in the HMD 110. Further, the position sensor 130 is configured to detect information relating to positions, inclinations, and/or light emitting intensities of a plurality of detection points (not shown) provided in the external controller 320. The detection points are, for example, light emitting portions configured to emit infrared light or visible light. Further, the position sensor 130 may include an infrared sensor or a plurality of optical cameras.

The external controller 320 is used to control, for example, a movement of a finger object to be displayed in the virtual space. The external controller 320 may include a right-hand external controller to be used by being held by a right hand of the user U, and a left-hand external controller to be used by being held by a left hand of the user U. In at least one embodiment, the external controller 320 is wirelessly connected to HMD 110. In at least one embodiment, a wired connection exists between the external controller 320 and HMD 110. The right-hand external controller is a device configured to detect the position of the right hand and the movement of the fingers of the right hand of the user U. The left-hand external controller is a device configured to detect the position of the left hand and the movement of the fingers of the left hand of the user U. The external controller 320 may include a plurality of operation buttons, a plurality of detection points, a sensor, and a transceiver. For example, when the operation button of the external controller 320 is operated by the user U, a menu object may be displayed in the virtual space. Further, when the operation button of the external controller 320 is operated by the user U, the visual field of the user U on the virtual space may be changed (that is, the visual-field image may be changed). In this case, the control device 120 may move the virtual camera to a predetermined position based on an operation signal output from the external controller 320.

The control device 120 is capable of acquiring information on the position of the HMD 110 based on the information acquired from the position sensor 130, and accurately associating the position of the virtual camera in the virtual space with the position of the user U wearing the HMD 110 in the real space based on the acquired information on the position of the HMD 110. Further, the control device 120 is capable of acquiring information on the position of the external controller 320 based on the information acquired from the position sensor 130, and accurately associating the position of the finger object to be displayed in the virtual space based on a relative position relationship between the external controller 320 and the HMD 110 in the real space based on the acquired information on the position of the external controller 320.

Further, the control device 120 is capable of specifying each of the line of sight of the right eye of the user U and the line of sight of the left eye of the user U based on the information transmitted from the eye gaze sensor 140, to thereby specify a point of gaze being an intersection between the line of sight of the right eye and the line of sight of the left eye. Further, the control device 120 is capable of specifying a line-of-sight direction of the user U based on the specified point of gaze. In at least one embodiment, the line-of-sight direction of the user U is a line-of-sight direction of both eyes of the user U, and matches a direction of a straight line passing through the point of gaze and a midpoint of a line segment connecting between the right eye and the left eye of the user U.

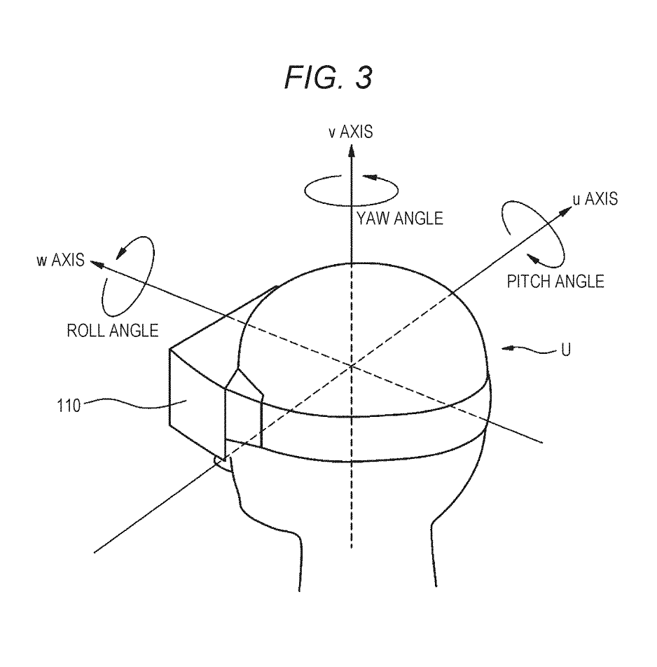

Next, with reference to FIG. 3, a method of acquiring information relating to a position and an inclination of the HMD 110 is described. FIG. 3 is a diagram of the head of the user U wearing the HMD 110 according to at least one embodiment of this disclosure. The information relating to the position and the inclination of the HMD 110, which are synchronized with the movement of the head of the user U wearing the HMD 110, can be detected by the position sensor 130 and/or the HMD sensor 114 mounted on the HMD 110. In FIG. 3, three-dimensional coordinates (uvw coordinates) are defined about the head of the user U wearing the HMD 110. A perpendicular direction in which the user U stands upright is defined as a v axis, a direction being orthogonal to the v axis and passing through the center of the HMD 110 is defined as a w axis, and a direction orthogonal to the v axis and the w axis is defined as a u direction. The position sensor 130 and/or the HMD sensor 114 are/is configured to detect angles about the respective uvw axes (that is, inclinations determined by a yaw angle representing the rotation about the v axis, a pitch angle representing the rotation about the u axis, and a roll angle representing the rotation about the w axis). The control device 120 is configured to determine angular information for controlling a visual axis of the virtual camera based on the detected change in angles about the respective uvw axes.

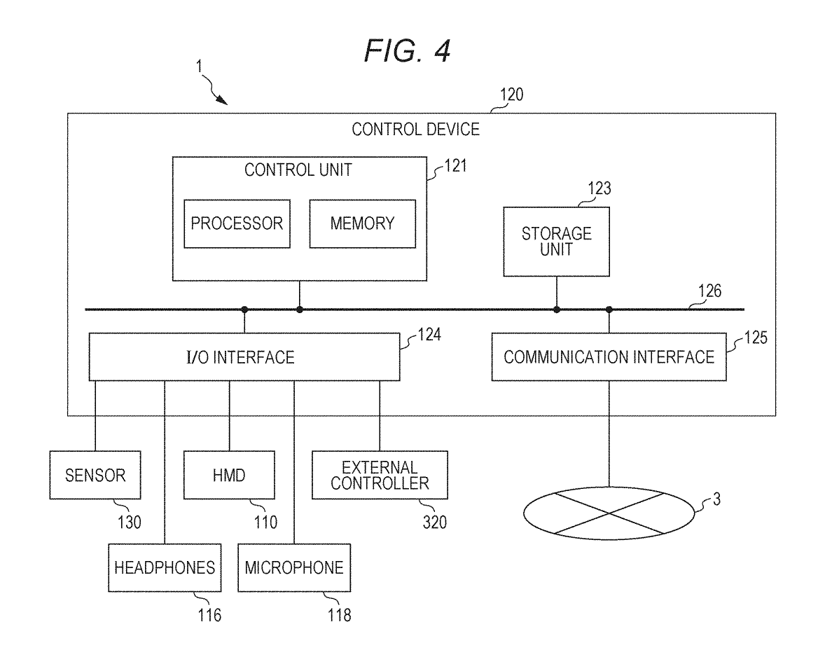

Next, with reference to FIG. 4, a hardware configuration of the control device 120 is described. FIG. 4 is a diagram of the hardware configuration of the control device 120 according to at least one embodiment of this disclosure. In FIG. 4, the control device 120 includes a control unit 121, a storage unit 123, an input/output (I/O) interface 124, a communication interface 125, and a bus 126. The control unit 121, the storage unit 123, the I/O interface 124, and the communication interface 125 are connected to each other via the bus 126 so as to enable communication therebetween.

The control device 120 may be constructed as a personal computer, a tablet computer, or a wearable device separately from the HMD 110, or may be built into the HMD 110. Further, a part of the functions of the control device 120 may be performed by a device mounted to the HMD 110, and other functions of the control device 120 may be performed by a separated device separate from the HMD 110.

The control unit 121 includes a memory and a processor. The memory is constructed of, for example, a read only memory (ROM) having various programs and the like stored therein or a random access memory (RAM) having a plurality of work areas in which various programs to be executed by the processor are stored. The processor is constructed of, for example, a central processing unit (CPU), a micro processing unit (MPU) and/or a graphics processing unit (GPU), and is configured to expand, on the RAM, programs designated by various programs installed into the ROM to execute various types of processing in cooperation with the RAM.

In particular, the control unit 121 may control various operations of the control device 120 by causing the processor to expand, on the RAM, a program (to be described later) for causing a computer to execute the information processing method according to at least one embodiment and execute the program in cooperation with the RAM. The control unit 121 executes a predetermined application program (game program) stored in the memory or the storage unit 123 to display a virtual space (visual-field image) on the display unit 112 of the HMD 110. With this, the user U can be immersed in the virtual space displayed on the display unit 112.

The storage unit (storage) 123 is a storage device, for example, a hard disk drive (HDD), a solid state drive (SSD), or a USB flash memory, and is configured to store programs and various types of data. The storage unit 123 may store the program for executing the information processing method according to at least one embodiment on a computer. Further, the storage unit 123 may store programs for authentication of the user U and game programs including data relating to various images and objects. Further, a database including tables for managing various types of data may be constructed in the storage unit 123.

The I/O interface 124 is configured to connect each of the position sensor 130, the HMD 110, the external controller 320, the headphones 116, and the microphone 118 to the control device 120 so as to enable communication therebetween, and is constructed of, for example, a universal serial bus (USB) terminal, a digital visual interface (DVI) terminal, or a high-definition multimedia interface (HDMI®) terminal. The control device 120 may be wirelessly connected to each of the position sensor 130, the HMD 110, the external controller 320, the headphones 116, and the microphone 118.

The communication interface 125 is configured to connect the control device 120 to the communication network 3, for example, a local area network (LAN), a wide area network (WAN), or the Internet. The communication interface 125 includes various wire connection terminals and various processing circuits for wireless connection for communication to/from an external device, for example, the game server 2, via the communication network 3, and is configured to become compatible with communication standards for communication via the communication network 3.

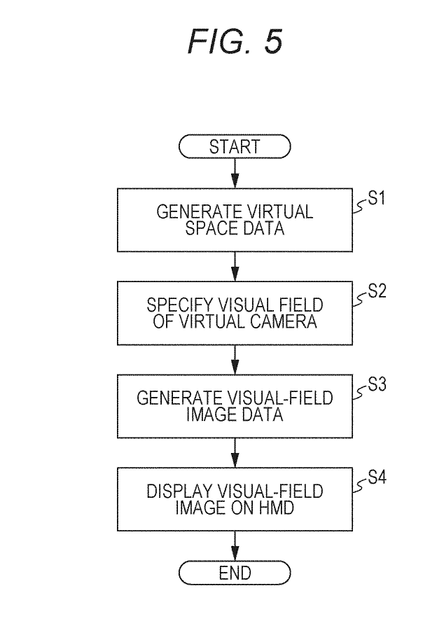

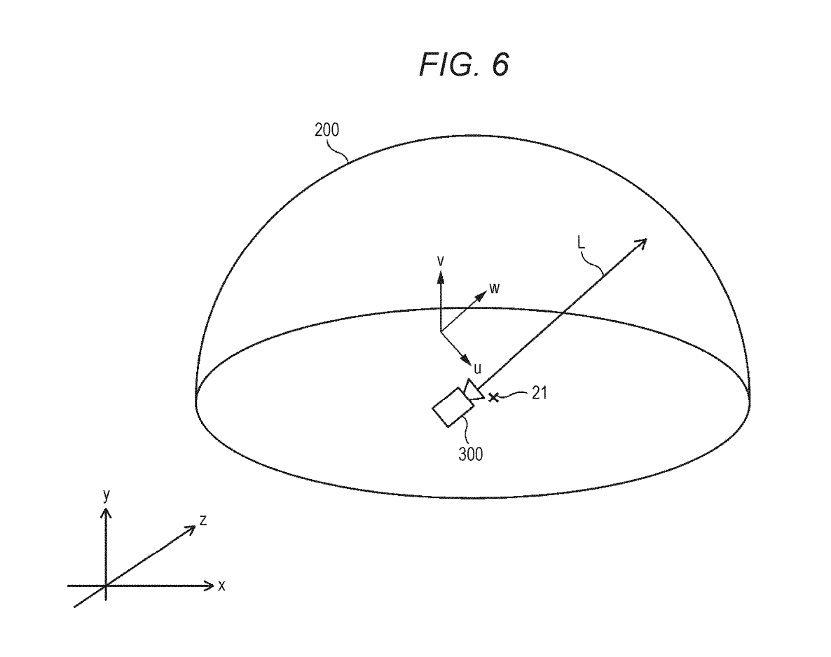

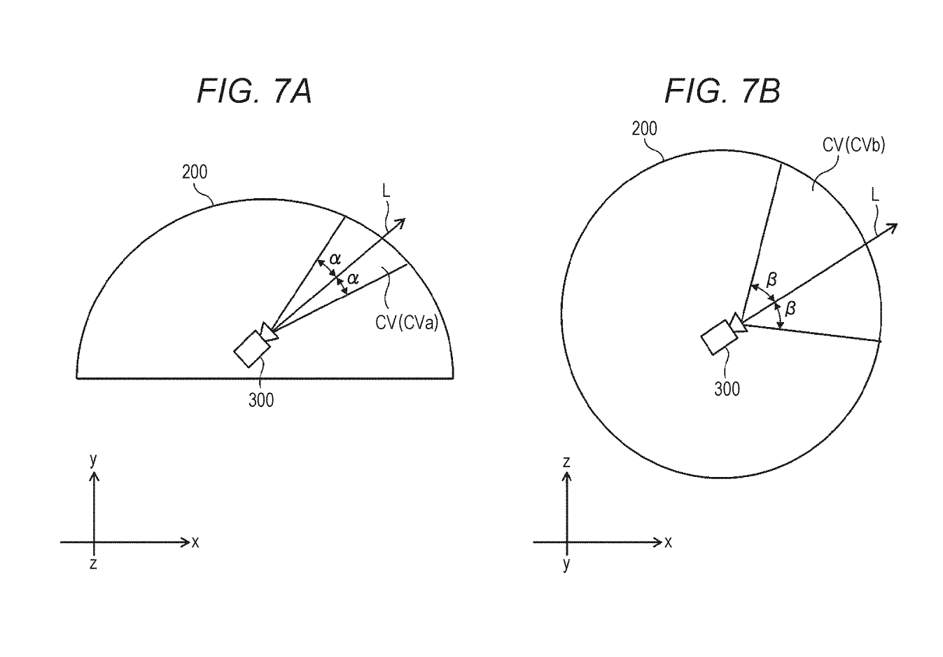

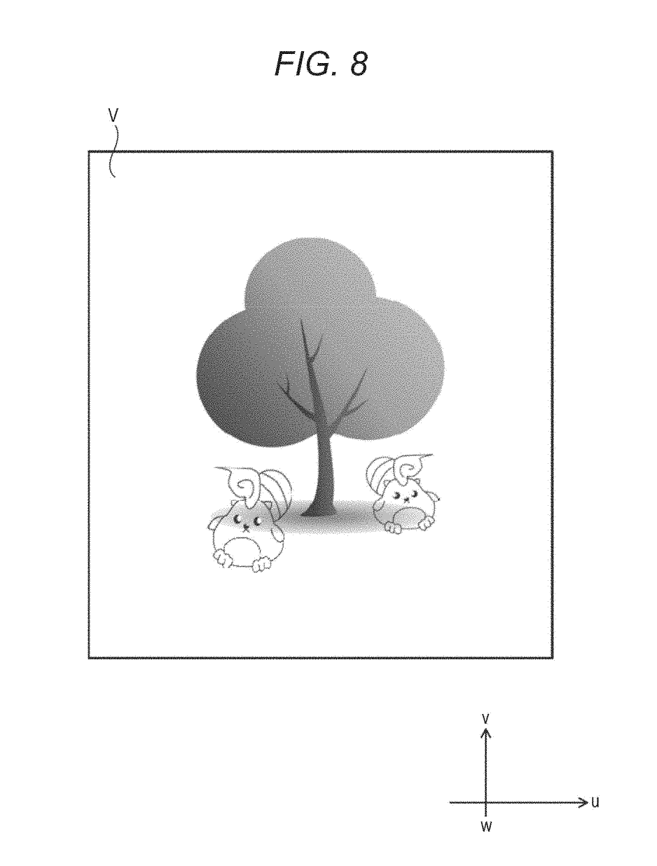

Next, with reference to FIG. 5 to FIG. 8, processing of displaying the visual-field image on the HMD 110 is described. FIG. 5 is a flowchart of a method of displaying the visual-field image on the HMD 110 according to at least one embodiment of this disclosure. FIG. 6 is an xyz spatial diagram of a virtual space 200 according to at least one embodiment of this disclosure. FIG. 7(a) is a yx plane diagram of the virtual space 200 according to at least one embodiment of this disclosure. FIG. 7(b) is a zx plane diagram of the virtual space 200 according to at least one embodiment of this disclosure. FIG. 8 is a diagram of a visual-field image V displayed on the HMD 110 according to at least one embodiment.

In FIG. 5, in Step S1, the control unit 121 (refer to FIG. 4) generates virtual space data representing the virtual space 200 including a virtual camera 300 and various objects. In FIG. 6, the virtual space 200 is defined as an entire celestial sphere having a center position 21 as the center (in FIG. 6, only the upper-half celestial sphere is included for simplicity). Further, in the virtual space 200, an xyz coordinate system having the center position 21 as the origin is set. The virtual camera 300 defines a visual axis L for specifying the visual-field image V (refer to FIG. 8) to be displayed on the HMD 110. The uvw coordinate system that defines the visual field of the virtual camera 300 is determined so as to synchronize with the uvw coordinate system that is defined about the head of the user U in the real space. Further, the control unit 121 may move the virtual camera 300 in the virtual space 200 in synchronization with the movement in the real space of the user U wearing the HMD 110.

Next, in Step S2, the control unit 121 specifies a visual field CV (refer to FIG. 7) of the virtual camera 300. Specifically, the control unit 121 acquires information relating to a position and an inclination of the HMD 110 based on data representing the state of the HMD 110, which is transmitted from the position sensor 130 and/or the HMD sensor 114. Next, the control unit 121 specifies the position and the direction of the virtual camera 300 in the virtual space 200 based on the information relating to the position and the inclination of the HMD 110. Next, the control unit 121 determines the visual axis L of the virtual camera 300 based on the position and the direction of the virtual camera 300, and specifies the visual field CV of the virtual camera 300 based on the determined visual axis L. In at least one embodiment, the visual field CV of the virtual camera 300 corresponds to a part of the region of the virtual space 200 that can be visually recognized by the user U wearing the HMD 110 (in other words, corresponds to a part of the region of the virtual space 200 to be displayed on the HMD 110). Further, the visual field CV has a first region CVa set as an angular range of a polar angle α about the visual axis L in the xy plane illustrated in FIG. 7 (a), and a second region CVb set as an angular range of an azimuth β about the visual axis L in the xz plane illustrated in FIG. 7 (b). The control unit 121 may specify the line-of-sight direction of the user U based on data representing the line-of-sight direction of the user U, which is transmitted from the eye gaze sensor 140, and may determine the direction of the virtual camera 300 based on the line-of-sight direction of the user U.

As described above, the control unit 121 can specify the visual field CV of the virtual camera 300 based on the data transmitted from the position sensor 130 and/or the HMD sensor 114. In at least one embodiment, when the user U wearing the HMD 110 moves, the control unit 121 can change the visual field CV of the virtual camera 300 based on the data representing the movement of the HMD 110, which is transmitted from the position sensor 130 and/or the HMD sensor 114. That is, the control unit 121 can change the visual field CV in accordance with the movement of the HMD 110. Similarly, when the line-of-sight direction of the user U changes, the control unit 121 can move the visual field CV of the virtual camera 300 based on the data representing the line-of-sight direction of the user U, which is transmitted from the eye gaze sensor 140. That is, the control unit 121 can change the visual field CV in accordance with the change in the line-of-sight direction of the user U.

Next, in Step S3, the control unit 121 generates visual-field image data representing the visual-field image V to be displayed on the display unit 112 of the HMD 110. Specifically, the control unit 121 generates the visual-field image data based on the virtual space data for defining the virtual space 200 and the visual field CV of the virtual camera 300.

Next, in Step S4, the control unit 121 displays the visual-field image V on the display unit 112 of the HMD 110 based on the visual-field image data (refer to FIGS. 7(a) and (b)). As described above, the visual field CV of the virtual camera 300 changes in accordance with the movement of the user U wearing the HMD 110, and thus the visual-field image V (see FIG. 8) to be displayed on the display unit 112 of the HMD 110 changes as well. Thus, the user U can be immersed in the virtual space 200.

The virtual camera 300 may include a left-eye virtual camera and a right-eye virtual camera. In this case, the control unit 121 generates left-eye visual-field image data representing a left-eye visual-field image based on the virtual space data and the visual field of the left-eye virtual camera. Further, the control unit 121 generates right-eye visual-field image data representing a right-eye visual-field image based on the virtual space data and the visual field of the right-eye virtual camera. After that, the control unit 121 displays the left-eye visual-field image and the right-eye visual-field image on the display unit 112 of the HMD 110 based on the left-eye visual-field image data and the right-eye visual-field image data. In this manner, the user U can visually recognize the visual-field image as a three-dimensional image from the left-eye visual-field image and the right-eye visual-field image. For the sake of convenience in description, the number of the virtual cameras 300 is one herein. As a matter of course, embodiments of this disclosure are also applicable to a case where the number of the virtual cameras is two or more.

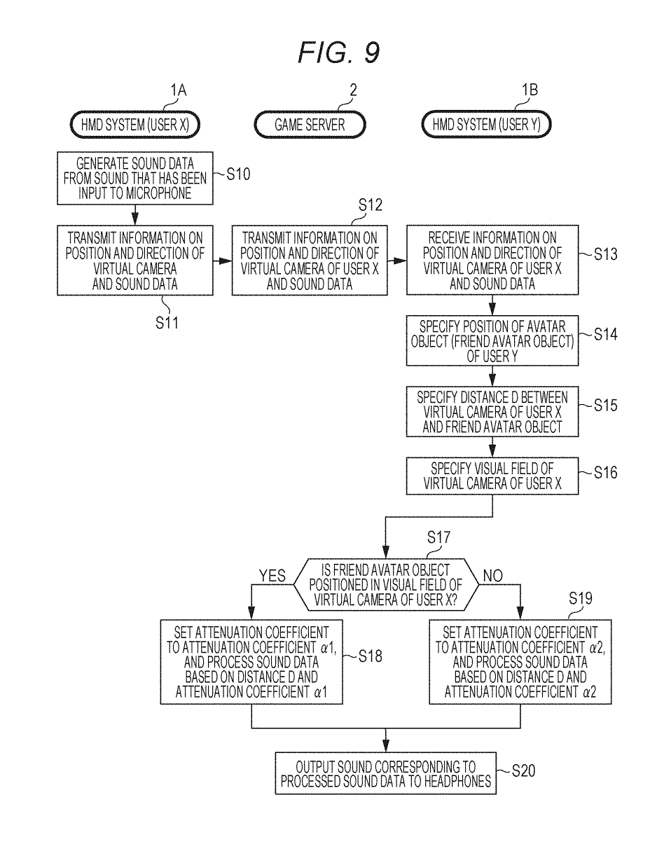

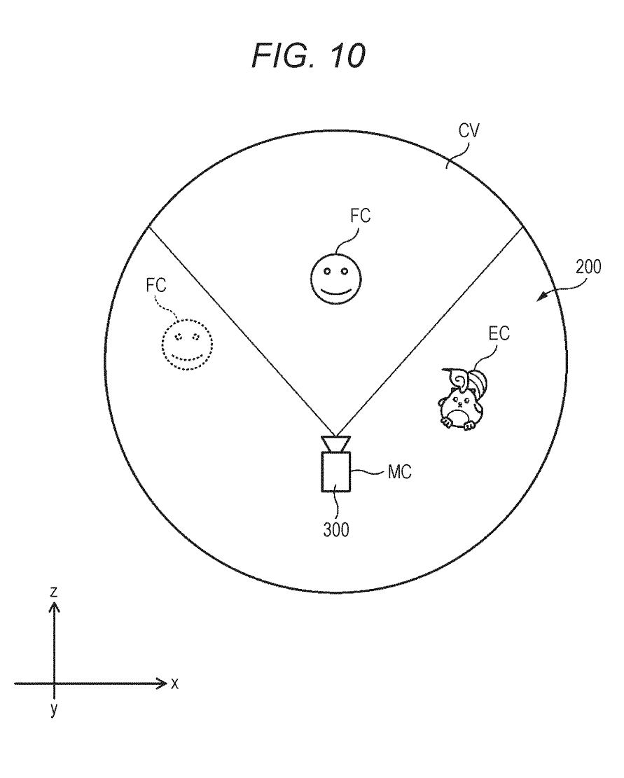

Next, an information processing method according to at least one embodiment is described with reference to FIG. 9 and FIG. 10. FIG. 9 is a flowchart of the information processing method according to at least one embodiment of this disclosure. FIG. 10 is a diagram including a friend avatar object FC positioned in the visual field CV of the virtual camera 300 and an enemy avatar object EC positioned outside the visual field CV of the virtual camera 300, which is exhibited when the virtual camera 300 and the sound source object MC are integrally constructed according to at least one embodiment of this disclosure.

First, in FIG. 10, a virtual space 200 includes the virtual camera 300, the sound source object MC, the friend avatar object FC, and the enemy avatar object EC. The control unit 121 is configured to generate virtual space data for defining the virtual space 200 including those objects.

The virtual camera 300 is associated with the HMD system 1A operated by the user X (refer to FIG. 9). More specifically, the position and direction (i.e., visual field CV of virtual camera 300) of the virtual camera 300 are changed in accordance with the movement of the HMD 110 worn by the user X. The sound source object MC is defined as a sound source of the sound from the user X input to the microphone 118 (refer to FIG. 1). The sound source object MC is integrally constructed with the virtual camera 300. When the sound source object MC and the virtual camera 300 are integrally constructed, the virtual camera 300 may be construed as having a sound source function. The sound source object MC may be transparent. In such a case, the sound source object MC is not displayed on the visual-field image V. The sound source object MC may also be separated from the virtual camera 300. For example, the sound source object MC may be close to the virtual camera 300 and be configured to follow the virtual camera 300 (i.e., the sound source object MC may be configured to move in accordance with a movement of the virtual camera 300).

The friend avatar object FC is associated with the HMD system 1B operated by the user Y (refer to FIG. 9). More specifically, the friend avatar object FC is the avatar object of the user Y, and is controlled based on operations performed by the user Y. The friend avatar object FC may function as a sound collector configured to collect sounds propagating on the virtual space 200. In other words, the friend avatar object FC may be integrally constructed with the sound collecting object configured to collect sounds propagating on the virtual space 200.

The enemy avatar object EC is controlled through operations performed by a user Z, different from user X and user Y. That is, the enemy avatar object EC is controlled through operations performed by the user Z. The enemy avatar object EC may function as a sound collector configured to collect sounds propagating on the virtual space 200. In other words, the enemy avatar object EC may be integrally constructed with the sound collecting object configured to collect sounds propagating on the virtual space 200. In at least one embodiment, there is an assumption that when the users X to Z are playing an online game that many people can join, the user X and the user Y are friends, and the user Z is an enemy of the user X and the user Y.

Next, how sound uttered by the user X is output from the headphones 116 of the user Y is described with reference to FIG. 9. In FIG. 9, when the user X utters a sound toward the microphone 118, the microphone 118 of the HMD system 1A collects the sound uttered from the user X, and generates sound data representing the collected sound (Step S10). The microphone 118 then transmits the sound data to the control unit 121, and the control unit 121 acquires the sound data corresponding to the sound of the user X. The control unit 121 of the HMD system 1A transmits information on the position and the direction of the virtual camera 300 and the sound data to the game server 2 via the communication network 3 (Step S11).

The game server 2 receives the information on the position and the direction of the virtual camera 300 of the user X and the sound data from the HMD system 1A, and then transmits that information and the sound data to the HMD system 1B (Step S12). The control unit 121 of the HMD system 1B then receives the information on the position and the direction of the virtual camera 300 of the user X and the sound data via the communication network 3 and the communication interface 125 (Step S13).

Next, the control unit 121 of the HMD system 1B (hereinafter simply referred to as “control unit 121”) determines the position of the avatar object of the user Y (Step S14). The position of the avatar object of the user Y corresponds to the position of friend avatar object FC, which is viewed from the perspective of user X. The control unit 121 then specifies a distance D (example of relative positional relationship) between the virtual camera 300 (i.e., sound source object MC) of the user X and the friend avatar object FC (Step S15). The distance D may be the shortest distance between the virtual camera 300 of the user X and the friend avatar object FC. In at least one embodiment, because the virtual camera 300 and the sound source object MC are integrally constructed, the distance D between the virtual camera 300 and the friend avatar object FC corresponds to the distance between the sound source object MC and the friend avatar object FC. In at least one embodiment where the virtual camera 300 and the sound source object are not integrally constructed, the distance D is determine based on a distance between the sound source object MC and the friend avatar object FC.

Next, the control unit 121 specifies the visual field CV of the virtual camera 300 of the user X based on the position and the direction of the virtual camera 300 of the user X (Step S16). In Step S17, the control unit 121 judges whether or not the friend avatar object FC is positioned in the visual field CV of the virtual camera 300 of the user X.

When the friend avatar object FC is judged to be positioned in the visual field CV of the virtual camera 300 (example of first region) (YES in Step S17), the control unit 121 sets an attenuation coefficient for defining an attenuation amount per unit distance of the sound propagated through the virtual space 200 to an attenuation coefficient α1 (example of first attenuation coefficient), and processes the sound data based on the attenuation coefficient α1 and the distance D between the virtual camera 300 and the friend avatar object FC (Step S18). When the friend avatar object FC is positioned in the visual field CV, as in FIG. 10, the friend avatar object FC is displayed as the solid line.

On the other hand, when the friend avatar object FC is judged to be positioned outside the visual field CV of the virtual camera 300 (example of second region) (NO in Step S17), the control unit 121 sets the attenuation coefficient to an attenuation coefficient α2 (example of second attenuation coefficient), and processes the sound data based on the attenuation coefficient α2 and the distance D between the virtual camera 300 and the friend avatar object FC (Step S19). When the friend avatar object FC is positioned outside the visual field CV, as in FIG. 10, the friend avatar object FC′ is displayed as the dashed line. The attenuation coefficient α1 and the attenuation coefficient α2 are different, and α1<α2.

Next, in Step S20, the control unit 121 causes the headphones 116 of the HMD system 1B to output the sound corresponding to the processed sound data.

In at least one embodiment, because the virtual camera 300 and the sound source object MC are integrally constructed and the friend avatar object FC has a sound collecting function, when the distance D between the virtual camera 300 of the user X and the friend avatar object FC is large, the volume (i.e., sound pressure level) of the sound output to the headphones 116 of the HMD system 1B is smaller (in other words, the attenuation coefficient (dB) of the sound is large). Conversely, when the distance D between the virtual camera 300 of the user X and the friend avatar object FC is small, the volume (i.e., sound pressure level) of the sound output to the headphones 116 of the HMD system 1B is larger (i.e., the attenuation coefficient (dB) of the sound is small).

When the attenuation coefficient is large, the volume (i.e., sound pressure level) of the sound output to the headphones 116 of the HMD system 1B is smaller (in other words, the attenuation coefficient (dB) of the sound is large). Conversely, when the attenuation coefficient is small, the volume (i.e., sound pressure level) of the sound output to the headphones 116 of the HMD system 1B is larger (i.e., the attenuation coefficient (dB) of the sound is small). In this way, the control unit 121 is configured to determine the volume (i.e., sound pressure level) of the sound data based on the attenuation coefficient and the distance D between the virtual camera 300 of the user X and the friend avatar object FC.

The control unit 121 may also be configured to determine the volume of the sound data by referring to a mathematical function representing a relation among a distance D between the virtual camera 300 of the user X and the friend avatar object FC, the attenuation coefficient α, the sound data, and a volume L. In at least one embodiment, when the volume at a reference distance D0 is known, the control unit 121 may be configured to determine the volume L of the sound data by referring to Expression (1), for example. Expression (1) is merely a non-limiting example, and the volume L of the sound data may be determined by using another expression.

L=L0−20 log(D/D0)−8.7α(D/D0) (1)

D: Distance between virtual camera 300 of user X and friend avatar object FC

D0: Reference distance between virtual camera 300 of user X and friend avatar object FC

L: Volume (dB) of sound data at distance D

L0: Volume (dB) of sound data at distance D0

α: Attenuation coefficient (dB/distance)

When the friend avatar object FC is present in the visual field CV, the attenuation coefficient α is the attenuation coefficient α1. However, when the friend avatar object FC is present outside the visual field CV, the attenuation coefficient α is the attenuation coefficient α2. The attenuation coefficient α1 is smaller than the attenuation coefficient α2. As a result, the volume of the sound data at a distance D1 between the virtual camera 300 of the user X and the friend avatar object FC when the friend avatar object FC is present in the visual field CV is larger than the volume of the sound data at the distance D1 between the virtual camera 300 of the user X and the friend avatar object FC when the friend avatar object FC is present outside the visual field CV. More specifically, because different attenuation coefficients α1 and α2 are set for inside and outside the visual field CV, directivity can be conferred on the sound to be output from the sound source object MC (i.e., virtual camera 300) in the virtual space 200.

The control unit 121 may also be configured to determine a predetermined head transmission function based on a relative positional relationship between the virtual camera 300 of the user X and the friend avatar object FC, and to process the sound data based on the determined head transmission function and the sound data.

According to at least one embodiment, when the friend avatar object FC is judged to be positioned in the visual field CV, the attenuation coefficient α is set to the attenuation coefficient α1, and the sound data is then processed based on the distance D and the attenuation coefficient α1. On the other hand, when the friend avatar object FC is judged to be positioned outside the visual field CV, the attenuation coefficient α is set to the attenuation coefficient α2, and the sound data is then processed based on the distance D and the attenuation coefficient α2. In this way, the volume (i.e., sound pressure level) of the sound to be output from the headphones 116 is different depending on the position of the friend avatar object FC on the virtual space 200. In at least one embodiment, because α1<α2, as in FIG. 10, when the friend avatar object FC is present in the visual field CV and the enemy avatar object EC is present outside the visual field CV, the volume of the sound to be output from the headphones 116 worn by the user Y operating the friend avatar object FC is larger than the volume of the sound to be output from the headphones 116 worn by the user Z operating the enemy avatar object EC. As a result, the user X can issue a sound-based instruction to the user Y operating the friend avatar object FC without the user Z operating the enemy avatar object EC noticing. Therefore, the entertainment value of the virtual space 200 can be improved.

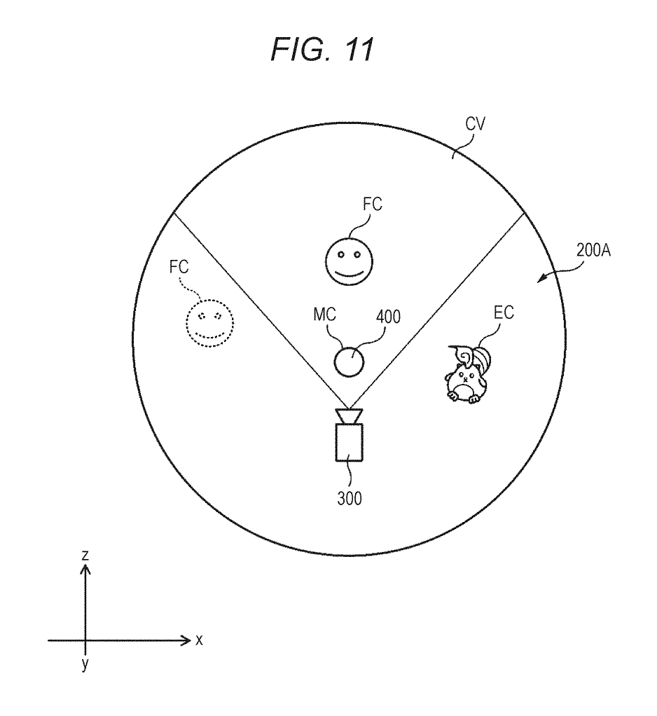

Next, at least one embodiment is described with reference to FIG. 11. FIG. 11 is a diagram including the self avatar object 400 and the friend avatar object FC positioned in the visual field CV of the virtual camera 300 and the enemy avatar object EC positioned outside the visual field CV of the virtual camera 300, which is exhibited when the self avatar object 400 and the sound source object MC are integrally constructed according to at least one embodiment of this disclosure.

First, in FIG. 11, the virtual space 200A includes the virtual camera 300, the sound source object MC, the self avatar object 400, the friend avatar object FC, and the enemy avatar object EC. The control unit 121 is configured to generate virtual space data for defining the virtual space 200 including those objects. The self avatar object 400 is an avatar object controlled based on operations by the user X (i.e., is an avatar object associated with user X).

The virtual space 200A in FIG. 11 is different from the virtual space 200 in FIG. 10 in that the self avatar object 400 is arranged, and in that the sound source object MC is integrally constructed with the self avatar object 400. Therefore, in the virtual space 200 in FIG. 10, the perspective of the virtual space presented to the user is a first-person perspective, but in the virtual space 200A illustrated in FIG. 11, the perspective of the virtual space presented to the user is a third-person perspective. When the self avatar object 400 and the sound source object MC are integrally constructed, the self avatar object 400 may be construed as having a sound source function.

Next, the information processing method according to at least one embodiment is now described with reference to FIG. 9 with the arrangement of objects in FIG. 11. In this description, differences between the already-described information processing method based on the arrangement of objects in FIG. 10 are described in detail for the sake of brevity. In the information processing method according to the first modification example, the processing of Step S10 to S13 in FIG. 9 is executed. In Step S14, the control unit 121 of the HMD system 1B (hereinafter simply referred to as “control unit 121”) specifies the position of the avatar object (i.e., friend avatar object FC) of the user Y and the position of the avatar object (i.e., self avatar object 400) of the user X. In at least one embodiment, the HMD system 1A may be configured to transmit position information, for example, on the self avatar object 400 to the game server 2 at a predetermined time interval, and the game server 2 may be configured to transmit the position information, for example, on the self avatar object 400 to the HMD system 1B at a predetermined time interval.

Next, in Step S15, the control unit 121 specifies a distance Da (example of relative positional relationship) between the self avatar object 400 (i.e., sound source object MC) and the friend avatar object FC. The distance Da may be the minimum distance between the self avatar object 400 and the friend avatar object FC. Because the self avatar object 400 and the sound source object MC are integrally constructed, the distance Da between the self avatar object 400 and the friend avatar object FC corresponds to the distance between the sound source object MC and the friend avatar object FC.

Then, the control unit 121 executes the judgement processing defined in Step S17. When the friend avatar object FC is judged to be positioned in the visual field CV of the virtual camera 300 (YES in Step S17), the control unit 121 sets the attenuation coefficient to the attenuation coefficient α1, and processes the sound data based on the attenuation coefficient α1 and the distance Da between the self avatar object 400 and the friend avatar object FC (Step S18).

On the other hand, when the friend avatar object FC is judged to be positioned outside the visual field CV of the virtual camera 300 (NO in Step S17), the control unit 121 sets the attenuation coefficient to the attenuation coefficient α2, and processes the sound data based on the attenuation coefficient α2 and the distance Da between the self avatar object 400 and the friend avatar object FC (Step S19).

Next, in Step S20, the control unit 121 causes the headphones 116 of the HMD system 1B to output the sound corresponding to the processed sound data.

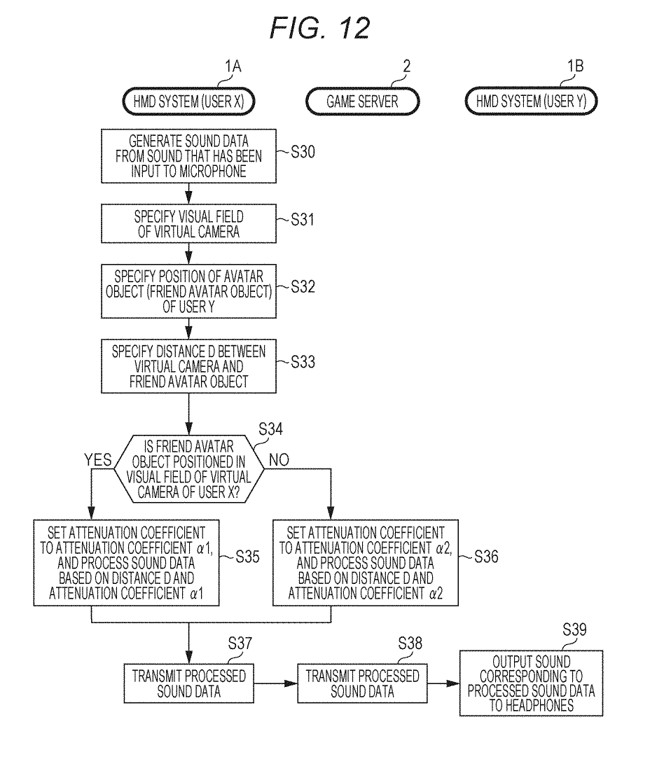

Next, an information processing method according to at least one embodiment is described with reference to FIG. 12. The information processing method according to the at least one embodiment of FIG. 12 is different from the information processing method according to the at least one embodiment of FIG. 9 in that the sound data is processed by the HMD system 1A. FIG. 12 is a flowchart of the information processing method according to at least one embodiment of this disclosure.

In FIG. 12, in Step S30, the microphone 118 of the HMD system 1A collects sound uttered from the user X, and generates sound data representing the collected sound. Next, the control unit 121 of the HMD system 1A (hereinafter simply referred to as “control unit 121”) specifies, based on the position and direction of the virtual camera 300 of the user X, the visual field CV of the virtual camera 300 of the user X (Step S31). Then, the control unit 121 specifies the position of the avatar object of the user Y (i.e., friend avatar object FC) (Step S32). The HMD system 1B may be configured to transmit position information, for example, on the friend avatar object FC to the game server 2 at a predetermined time interval, and the game server 2 may be configured to transmit the position information, for example, on the friend avatar object FC to the HMD system 1B at a predetermined time interval.

In Step S33, the control unit 121 specifies the distance D between the virtual camera 300 (i.e., sound source object MC) of the user X and the friend avatar object FC. Next, the control unit 121 judges whether or not the friend avatar object FC is positioned in the visual field CV of the virtual camera 300 of the user X. When the friend avatar object FC is judged to be positioned in the visual field CV of the virtual camera 300 (YES in Step S34), the control unit 121 sets the attenuation coefficient to the attenuation coefficient α1, and processes the sound data based on the attenuation coefficient α1 and the distance D between the virtual camera 300 and the friend avatar object FC (Step S35). On the other hand, when the friend avatar object FC is judged to be positioned outside the visual field CV of the virtual camera 300 (NO in Step S34), the control unit 121 sets the attenuation coefficient to the attenuation coefficient α2, and processes the sound data based on the attenuation coefficient α2 and the distance D between the virtual camera 300 and the friend avatar object FC (Step S36).

Then, the control unit 121 transmits the processed sound data to the game server 2 via the communication network 3 (Step S37). The game server 2 receives the processed sound data from the HMD system 1A, and then transmits the processed sound data to the HMD system 1B (Step S38). Next, the control unit 121 of the HMD system 1B receives the processed sound data from the game server 2, and causes the headphones 116 of the HMD system 1B to output the sound corresponding to the processed sound data (Step S39).

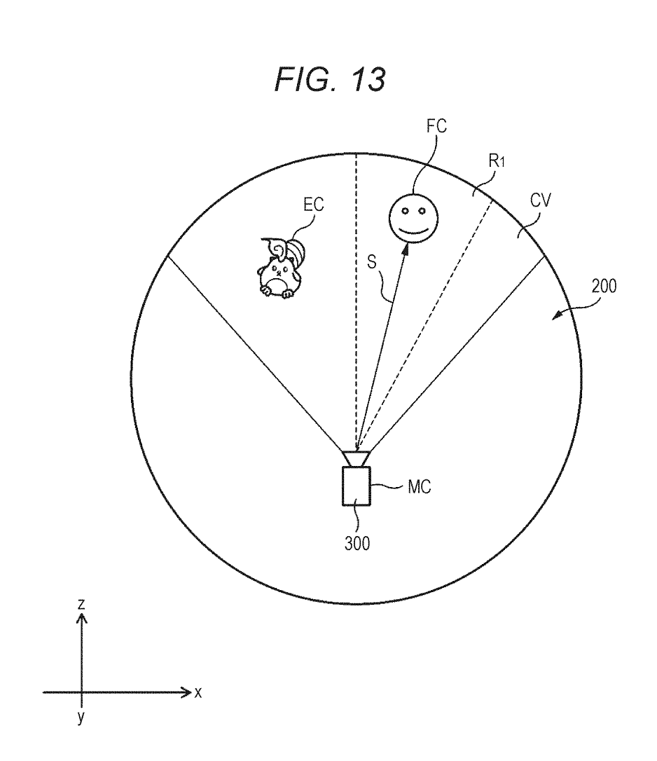

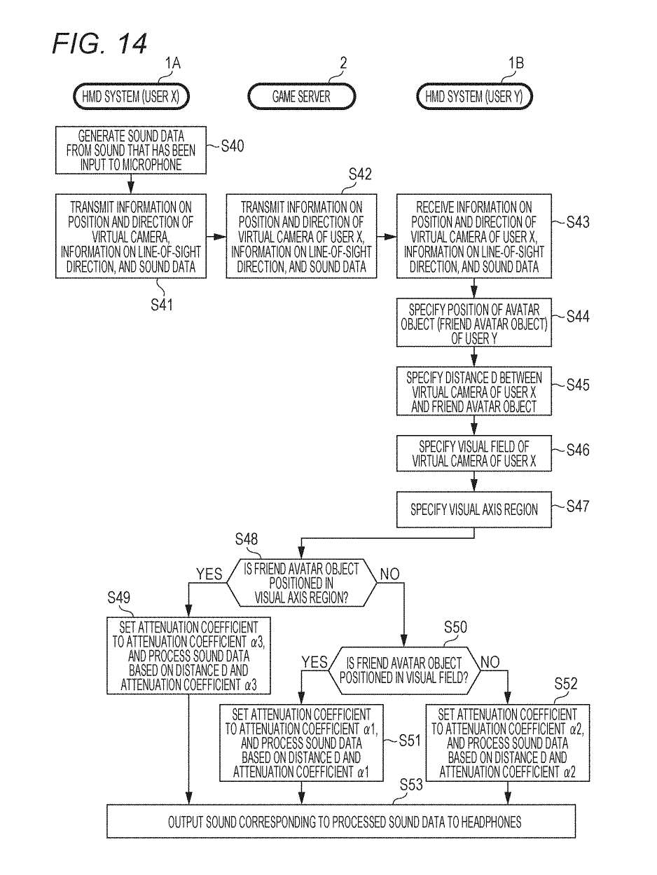

Next, an information processing method according to at least one embodiment is described with reference to FIG. 13 and FIG. 14. FIG. 13 is a diagram including the friend avatar object FC positioned in an eye gaze region R1 and the enemy avatar object EC positioned in the visual field CV of the virtual camera 300 other than the eye gaze region R1, which is exhibited when the virtual camera 300 and the sound source object MC are integrally constructed according to at least one embodiment of this disclosure. FIG. 14 is a flowchart of the information processing method according to at least one embodiment of this disclosure.

In the information processing method according to the at least one embodiment in FIG. 9, when the friend avatar object FC is positioned in the visual field CV of the virtual camera 300, the attenuation coefficient is set to the attenuation coefficient α1. However, when the friend avatar object FC is positioned outside the visual field CV of the virtual camera 300, the attenuation coefficient is set to the attenuation coefficient α2.

On the other hand, in the information processing method according the at least one embodiment in FIG. 13, when the friend avatar object FC is positioned in the eye gaze region R1 (example of first region) defined by a line-of-sight direction S of the user X, the attenuation coefficient is set to an attenuation coefficient α3. However, when the friend avatar object FC is positioned in the visual field CV of the virtual camera 300 other than the eye gaze region R1, the attenuation coefficient is set to the attenuation coefficient α1. When the friend avatar object FC is positioned outside the visual field CV of the virtual camera 300, the attenuation coefficient may be set to the attenuation coefficient α2. The attenuation coefficient α1, the attenuation coefficient α2, and the attenuation coefficient α3 are different from each other, and are, for example, set such that α3<α1<α2. In this way, the information processing method according to the at least one embodiment in FIG. 13 is different from the information processing method according to the at least one embodiment in FIG. 9 in that two different attenuation coefficients α3 and α1 are set in the visual field CV of the virtual camera 300.

The control unit 121 of the HMD system 1A is configured to specify the line-of-sight direction S of the user X based on data indicating the line-of-sight direction S of the user X transmitted from the eye gaze sensor 140 of the HMD system 1A. The eye gaze region R1 has a first region set as an angular range of a predetermined polar angle about the line-of-sight direction S in the xy plane, and a second region set as an angular range of a predetermined azimuth angle about the line-of-sight direction S in the xz plane. The predetermined polar angle and the predetermined azimuth angle may be set as appropriate in accordance with a specification of the game program.

Next, the information processing method according to at least one embodiment is described with reference to FIG. 14. In this description, only the differences between the already-described information processing method according to the at least one embodiment in FIG. 9 and the information processing method according to at least one embodiment in FIG. 14 are described in detail for the sake of brevity.

After the processing of Step S40, the HMD system 1A transmits information on the position and the direction of the virtual camera 300, information on the line-of-sight direction S, and the sound data to the game server 2 via the communication network 3 (Step S41). The game server 2 receives from the HMD system 1A the information on the position and the direction of the virtual camera 300 of the user X, the information on the line-of-sight direction S, and the sound data, and then transmits that information and sound data to the HMD system 1B (Step S42). Then, the control unit 121 of the HMD system 1B receives the information on the position and the direction of the virtual camera 300 of the user X, the information on the line-of-sight direction S, and the sound data via the communication network 3 and the communication interface 125 (Step S43).

Next, the control unit 121 of the HMD system 1B (hereinafter simply referred to as “control unit 121”) executes the processing of Steps S44 to S46, and then specifies the eye gaze region R1 based on the information on the line-of-sight direction S of the user X (Step S47). Next, the control unit 121 judges whether or not the friend avatar object FC is positioned in the eye gaze region R1 (Step S48). When the friend avatar object FC is judged to be positioned in the eye gaze region R1 (YES in Step S48), the control unit 121 sets the attenuation coefficient to the attenuation coefficient α3, and processes the sound data based on the attenuation coefficient α3 and the distance D between the virtual camera 300 of the user X and the friend avatar object FC (Step S49).

On the other hand, when the friend avatar object FC is judged to be positioned outside the eye gaze region R1 (NO in Step S48), the control unit 121 judges whether or not the friend avatar object FC is positioned in the visual field CV (Step S50). When the friend avatar object FC is judged to be positioned in the visual field CV (YES in Step S50), the control unit 121 sets the attenuation coefficient to the attenuation coefficient α1, and processes the sound data based on the attenuation coefficient α1 and the distance D between the virtual camera 300 of the user X and the friend avatar object FC (Step S51). When the friend avatar object FC is judged to be positioned outside the visual field CV (NO in Step S50), the control unit 121 sets the attenuation coefficient to the attenuation coefficient α2, and processes the sound data based on the attenuation coefficient α2 and the distance D between the virtual camera 300 of the user X and the friend avatar object FC (Step S52).

Next, in Step S53, the control unit 121 causes the headphones 116 of the HMD system 1B to output the sound corresponding to the processed sound data.

According to the at least one embodiment in FIG. 14, when the friend avatar object FC is judged to be positioned in the eye gaze region R1, the attenuation coefficient α is set to the attenuation coefficient α3, and the sound data is then processed based on the distance D and the attenuation coefficient α3. On the other hand, when the friend avatar object FC is judged to be positioned in the visual field CV of the virtual camera 300 other than the eye gaze region R1, the attenuation coefficient α is set to the attenuation coefficient α1, and the sound data is then processed based on the distance D and the attenuation coefficient α1.

In this way, the volume (i.e., sound pressure level) to be output from the headphones 116 is different depending on the position of the friend avatar object FC on the virtual space 200. In at least one embodiment, because α3<α1, as in FIG. 13, when the friend avatar object FC is present in the eye gaze region R1, and the enemy avatar object EC is present in the visual field CV other than the eye gaze region R1, the volume of the sound to be output from the headphones 116 worn by the user Y operating the friend avatar object FC is larger than the volume of the sound to be output from the headphones 116 worn by the user Z operating the enemy avatar object EC. As a result, the user X can issue a sound-based instruction to the user Y operating the friend avatar object FC without the user Z operating the enemy avatar object EC noticing. Therefore, the entertainment value of the virtual space 200 can be improved.

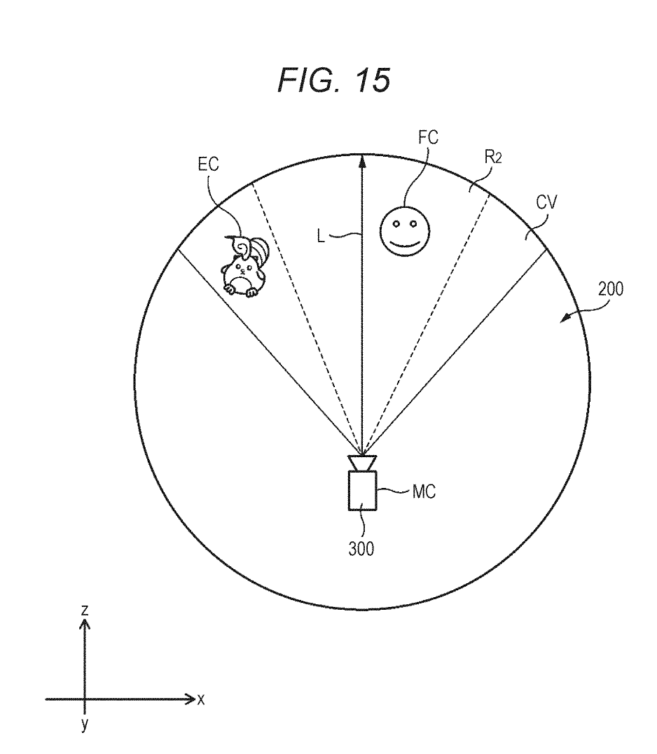

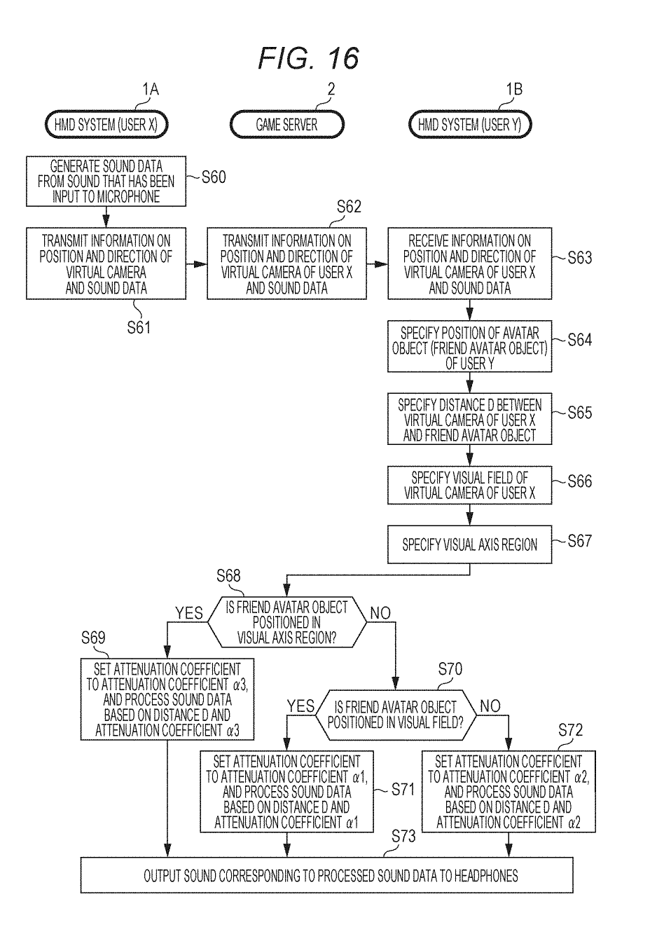

Next, an information processing method according to at least one embodiment is described with reference to FIG. 15 and FIG. 16. FIG. 15 is a diagram including the friend avatar object FC positioned in the visual axis region R2 and the enemy avatar object EC positioned in the visual field CV of the virtual camera 300 other than the visual axis region R2, which is exhibited when the virtual camera 300 and the sound source object MC are integrally constructed according to at least one embodiment of this disclosure. FIG. 16 is a flowchart of the information processing method according to at least one embodiment of this disclosure.

In the information processing method according to the at least embodiment in FIG. 9, when the friend avatar object FC is positioned in the visual field CV of the virtual camera 300, the attenuation coefficient is set to the attenuation coefficient α1. However, when the friend avatar object FC is positioned outside the visual field CV of the virtual camera 300, the attenuation coefficient is set to the attenuation coefficient α2.

On the other hand, in the information processing method according to at least one embodiment in FIG. 15, when the friend avatar object FC is positioned in the visual axis region R2 defined by the visual axis L of the virtual camera 300, the attenuation coefficient is set to an attenuation coefficient α3. However, when the friend avatar object FC is positioned in the visual field CV of the virtual camera 300 other than the visual axis region R2, the attenuation coefficient is set to the attenuation coefficient α1. When the friend avatar object FC is positioned outside the visual field CV of the virtual camera 300, the attenuation coefficient may be set to the attenuation coefficient α2. The attenuation coefficient α1, the attenuation coefficient α2, and the attenuation coefficient α3 are different from each other, and are, for example, set such that α3<α1<α2. In this way, similarly to the information processing method according to the at least one embodiment in FIG. 14, the information processing method according to at least one embodiment in FIG. 15 is different from the information processing method according to the at least one embodiment in FIG. 9 in that the two different attenuation coefficients α3 and α1 are set in the visual field CV of the virtual camera 300.

The control unit 121 of the HMD system 1A is configured to specify the visual axis L of the virtual camera 300 based on the position and the direction of the virtual camera 300. The visual axis region R2 has a first region set as an angular range of a predetermined polar angle about the line-of-sight direction S in the xy plane, and a second region set as an angular range of a predetermined azimuth angle about the line-of-sight direction S in the xz plane. The predetermined polar angle and the predetermined azimuth angle may be set as appropriate in accordance with a specification of the game program. The predetermined polar angle is smaller than the polar angle α for specifying the visual field CV of the virtual camera 300, and the predetermined azimuth angle is smaller than the azimuth angle β for specifying the visual field CV of the virtual camera 300.

Next, the information processing method according to at least one embodiment is described with reference to FIG. 16. In this description, only the differences between the already-described information processing method according to the at least one embodiment in FIG. 9 and the information processing method according to the at least one embodiment in FIG. 16 are described in detail.

The processing of Steps S60 to S66 corresponds to the processing of Steps S10 to S16 in FIG. 9, and hence a description of that processing is omitted here. In Step S67, the control unit 121 specifies the visual axis region R2 based on the visual axis L of the virtual camera 300 (Step S67). Next, the control unit 121 judges whether or not the friend avatar object FC is positioned in the visual axis region R2 (Step S68). When the friend avatar object FC is judged to be positioned in the visual axis region R2 (YES in Step S68), the control unit 121 sets the attenuation coefficient to the attenuation coefficient α3, and processes the sound data based on the attenuation coefficient α3 and the distance D between the virtual camera 300 of the user X and the friend avatar object FC (Step S69).

On the other hand, when the friend avatar object FC is judged to be positioned outside the visual axis region R2 (NO in Step S68), the control unit 121 judges whether or not the friend avatar object FC is positioned in the visual field CV (Step S70). When the friend avatar object FC is judged to be positioned in the visual field CV (YES in Step S70), the control unit 121 sets the attenuation coefficient to the attenuation coefficient α1, and processes the sound data based on the attenuation coefficient α1 and the distance D between the virtual camera 300 of the user X and the friend avatar object FC (Step S71). When the friend avatar object FC is judged to be positioned outside the visual field CV (NO in Step S70), the control unit 121 sets the attenuation coefficient to the attenuation coefficient α2, and processes the sound data based on the attenuation coefficient α2 and the distance D between the virtual camera 300 of the user X and the friend avatar object FC (Step S72).

Next, in Step S73, the control unit 121 causes the headphones 116 of the HMD system 1B to output the sound corresponding to the processed sound data.

According to the at least one embodiment in FIG. 16, when the friend avatar object FC is judged to be positioned in the visual axis region R2, the attenuation coefficient is set to the attenuation coefficient α3, and the sound data is then processed based on the distance D and the attenuation coefficient α3. On the other hand, when the friend avatar object FC is judged to be positioned in the visual field CV of the virtual camera 300 other than the visual axis region R2, the attenuation coefficient is set to the attenuation coefficient α1, and the sound data is then processed based on the distance D and the attenuation coefficient α2.

In this way, the volume (i.e., sound pressure level) to be output from the headphones 116 is different depending on the position of the friend avatar object FC on the virtual space 200. In at least one embodiment, because α3<α1, as in FIG. 15, when the friend avatar object FC is present in the visual axis region R2, and the enemy avatar object EC is present in the visual field CV other than the visual axis region R2, the volume of the sound to be output from the headphones 116 worn by the user Y operating the friend avatar object FC is larger than the volume of the sound to be output from the headphones 116 worn by the user Z operating the enemy avatar object EC. As a result, the user X can issue a sound-based instruction to the user Y operating the friend avatar object FC without the user Z operating the enemy avatar object EC noticing. Therefore, the entertainment value of the virtual space 200 can be improved.

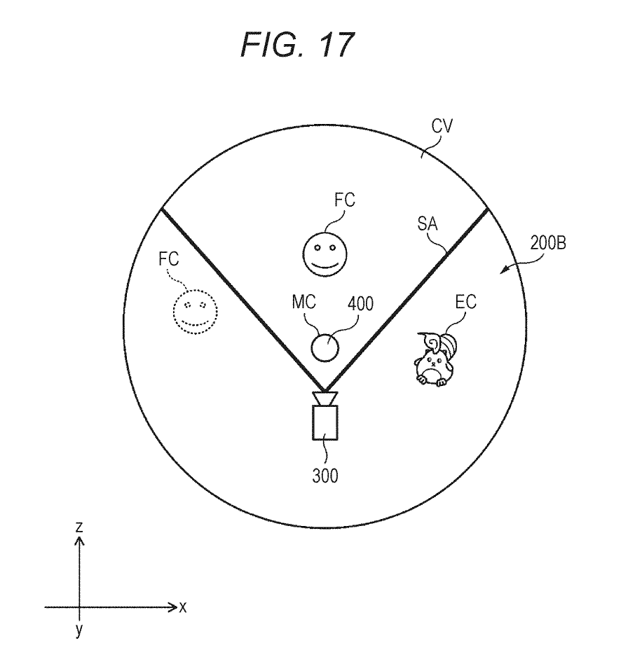

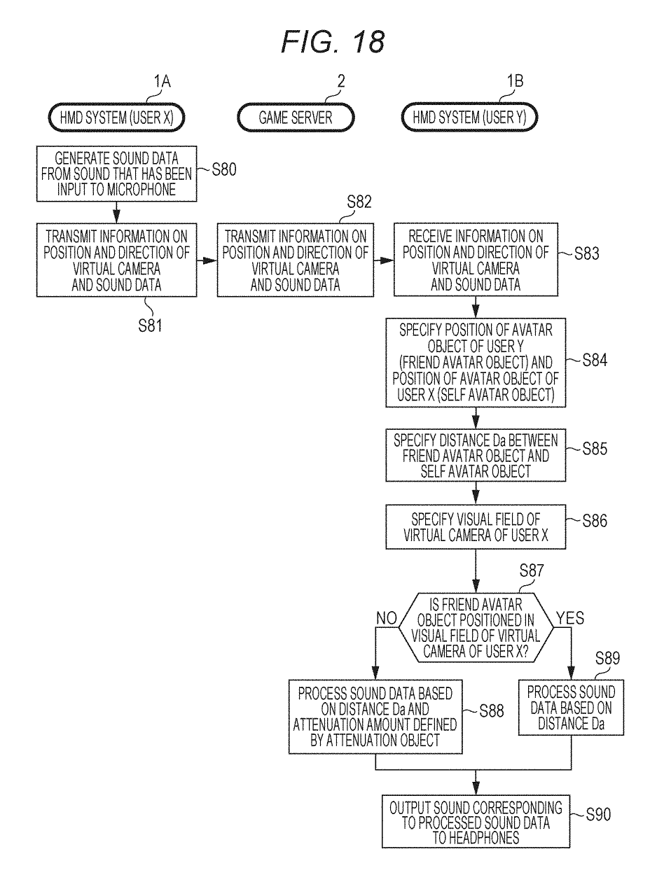

Next, an information processing method according to at least one embodiment of this disclosure is described with reference to FIG. 17 and FIG. 18. FIG. 17 is a diagram including the friend avatar object FC and the self avatar object 400 positioned on an inner side of an attenuation object SA and the enemy avatar object EC positioned on an outer side of the attenuation object SA, which is exhibited when the self avatar object 400 and the sound source object MC are integrally constructed according to at least one embodiment of this disclosure. FIG. 18 is a flowchart of the information processing method according to at least one embodiment of this disclosure.

First, in FIG. 17, a virtual space 200B includes the virtual camera 300, the sound source object MC, the self avatar object 400, the friend avatar object FC, the enemy avatar object EC, and the attenuation object SA. The control unit 121 is configured to generate virtual space data for defining the virtual space 200B including those objects. The information processing method according to the at least one embodiment in FIG. 18 is different from the information processing method according to the at least one embodiment in FIG. 9 in that the attenuation object SA is arranged.

The attenuation object SA is an object for defining the attenuation amount of the sound propagated through the virtual space 200B. The attenuation object SA is arranged on a boundary between inside the visual field CV of the virtual camera 300 (example of first region) and outside the visual field CV of the virtual camera 300 (example of second region). The attenuation object SA may be transparent, and does not have to be displayed in the visual-field image V (refer to FIG. 8) displayed on the HMD 110. In this case, directivity can be conferred on the sound that has been output from the sound source object MC without harming the sense of immersion of the user in the virtual space 200B (i.e., sense of being present in the virtual space 200B).

In the virtual space 200B in FIG. 17, the sound source object MC is integrally constructed with the self avatar object 400, and those objects are arranged in the visual field CV of the virtual camera 300.

Next, the information processing method according to at least one embodiment is described with reference to FIG. 18. The processing of Steps S80 to S83 in FIG. 18 corresponds to the processing of Steps S10 to S13 illustrated in FIG. 9, and hence a description of that processing is omitted here. In Step S84, the control unit 121 of the HMD system 1B (hereinafter simply referred to as “control unit 121”) specifies the position of the avatar object of the user Y (i.e., friend avatar object FC) and the position of the avatar object of the user X (i.e., self avatar object 400).

Next, in Step S85, the control unit 121 specifies the distance Da (example of relative positional relationship) between the self avatar object 400 (i.e., sound source object MC) and the friend avatar object FC. The distance Da may be the minimum distance between the self avatar object 400 and the friend avatar object FC. The distance Da between the self avatar object 400 and the friend avatar object FC corresponds to the distance between the sound source object MC and the friend avatar object FC. Next, the control unit 121 executes the processing of Steps S86 and S87. The processing of Steps S86 and S87 corresponds to the processing of Steps S16 and S17 in FIG. 9.

Then, when the friend avatar object FC is judged to be positioned outside the visual field CV of the virtual camera 300 (NO in Step S87), the control unit 121 processes the sound data based on an attenuation amount T defined by the attenuation object SA and the distance Da between the self avatar object 400 and the friend avatar object FC. In at least one embodiment, as in FIG. 17, the sound source object MC is positioned on an inner side of the attenuation object SA, and the friend avatar object FC′ is positioned on an outer side of the attenuation object SA. As a result, because the sound to the friend avatar object FC from the sound source object MC passes through the attenuation object SA, the volume (i.e., sound pressure level) of that sound is determined based on the distance Da and the attenuation amount T defined by the attenuation object SA.

On the other hand, when the friend avatar object FC is judged to be positioned in the visual field CV of the virtual camera 300 (YES in Step S87), the control unit 121 processes the sound data based on the distance Da between the self avatar object 400 and the friend avatar object FC. In at least one embodiment, as in FIG. 17, the sound source object MC and the friend avatar object FC (indicated by the solid line) are positioned on an inner side of the attenuation object SA. As a result, because the sound to the friend avatar object FC from the sound source object MC does not pass through the attenuation object SA, the volume (i.e., sound pressure level) of that sound is determined based on the distance Da.

Next, in Step S90, the control unit 121 causes the headphones 116 of the HMD system 1B to output the sound corresponding to the processed sound data.

According to at least one embodiment, when the sound source object MC is arranged in the visual field CV of the virtual camera 300 (i.e., inner side of the attenuation object SA), outside the visual field CV of the virtual camera 300, the sound to be output from the sound source object MC is further attenuated than in the visual field CV by the attenuation amount T defined by the attenuation object SA. As a result, directivity can be conferred on the sound to be output from the sound source object MC.

When the friend avatar object FC is judged to be positioned in the visual field CV (i.e., first region) in which the sound source object MC is positioned, the sound data is processed based on the distance Da. On the other hand, when the friend avatar object FC is judged to be positioned outside the visual field CV (i.e., second region), the sound data is processed based on the distance Da and the attenuation amount T defined by the attenuation object SA.

In this way, the volume (i.e., sound pressure level) to be output from the headphones 116 is different depending on the position of the friend avatar object FC on the virtual space 200B. The volume of the sound to be output from the headphones 116 when the friend avatar object FC is present in the visual field CV is larger than the volume of the sound to be output from the headphones 116 when the friend avatar object FC is present outside the visual field CV. As a result, when the friend avatar object FC is present in the visual field CV, and the enemy avatar object EC is present outside the visual field CV, the user X operating the self avatar object 400 can issue a sound-based instruction to the user Y operating the friend avatar object FC without the user Z operating the enemy avatar object EC noticing. Therefore, the entertainment value of the virtual space 200B can be improved.

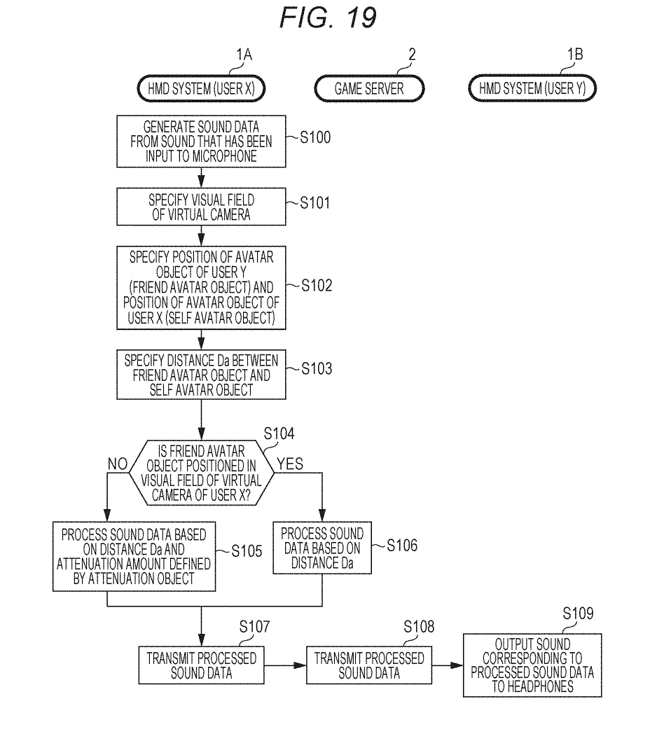

Next, an information processing method according to at least one embodiment is described with reference to FIG. 19. The information processing method according to the at least one embodiment in FIG. 19 is different from the information processing method the at least one embodiment in FIG. 18 in that the sound data is processed by the HMD system 1A. FIG. 19 is a flowchart of the information processing method according to at least one embodiment of this disclosure.

In FIG. 19, in Step S100, the microphone 118 of the HMD system 1A collects sound uttered from the user X, and generates sound data representing the collected sound. Next, the control unit 121 of the HMD system 1A (hereinafter simply referred to as “control unit 121”) specifies, based on the position and direction of the virtual camera 300 of the user X, the visual field CV of the virtual camera 300 of the user X (Step S101). Then, the control unit 121 specifies the position of the avatar object (i.e., friend avatar object FC) of the user Y and the position of the avatar object (i.e., self avatar object 400) of the user X (Step S102).

In Step S103, the control unit 121 specifies the distance Da between the self avatar object 400 and the friend avatar object FC. Next, the control unit 121 judges whether or not the friend avatar object FC is positioned in the visual field CV of the virtual camera 300 of the user X (Step S104). When the friend avatar object FC is judged to be positioned outside the visual field CV of the virtual camera 300 (NO in Step S104), the control unit 121 processes the sound data based on the attenuation amount T defined by the attenuation object SA and the distance Da between the self avatar object 400 and the friend avatar object FC. On the other hand, when the friend avatar object FC is judged to be positioned in the visual field CV of the virtual camera 300 (YES in Step S104), the control unit 121 processes the sound data based on the distance Da between the self avatar object 400 and the friend avatar object FC (Step S106).

Then, the control unit 121 transmits the processed sound data to the game server 2 via the communication network 3 (Step S107). The game server 2 receives the processed sound data from the HMD system 1A, and then transmits the processed sound data to the HMD system 1B (Step S108). Next, the control unit 121 of the HMD system 1B receives the processed sound data from the game server 2, and causes the headphones 116 of the HMD system 1B to output the sound corresponding to the processed sound data (Step S109).

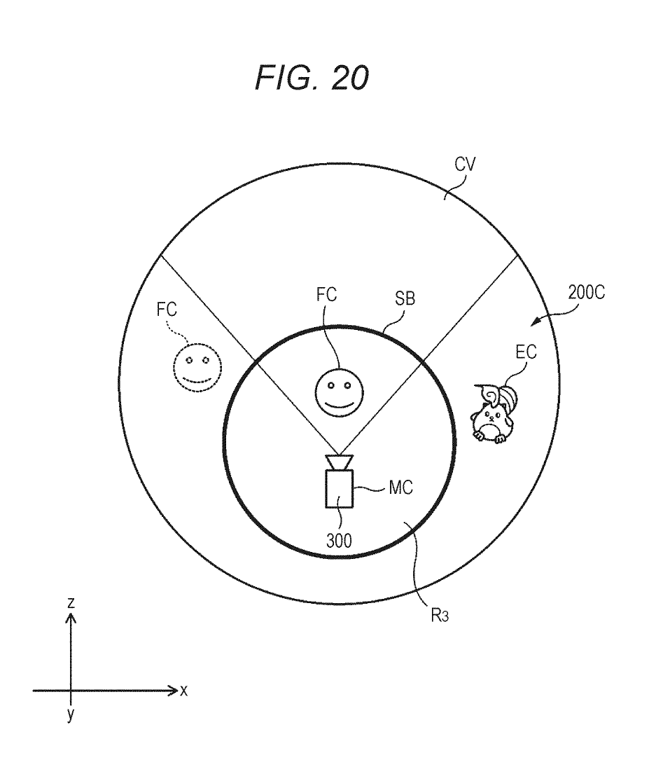

Next, an information processing method according to at least one is described with reference to FIG. 20. FIG. 20 is a diagram including the friend avatar object FC positioned on the inner side of the attenuation object SB and the enemy avatar object EC positioned on the outer side of the attenuation object SB, which is exhibited when the virtual camera 300 and the sound source object MC are integrally constructed according to at least one embodiment of this disclosure. In FIG. 20, in the virtual space 200C, the attenuation object SB is arranged so as to surround the virtual camera 300 (i.e., sound source object MC). When the friend avatar object FC (indicated by the solid line) is arranged in a region R3 on an inner-side R3 of the attenuation object SB, the sound data is processed based on the distance D between the virtual camera 300 and the friend avatar object FC. On the other hand, when the friend avatar object FC′ is arranged in a region on an outer side of the attenuation object SB, the sound data is processed based on the attenuation amount T defined by the attenuation object SB and the distance D between the virtual camera 300 and the friend avatar object FC.

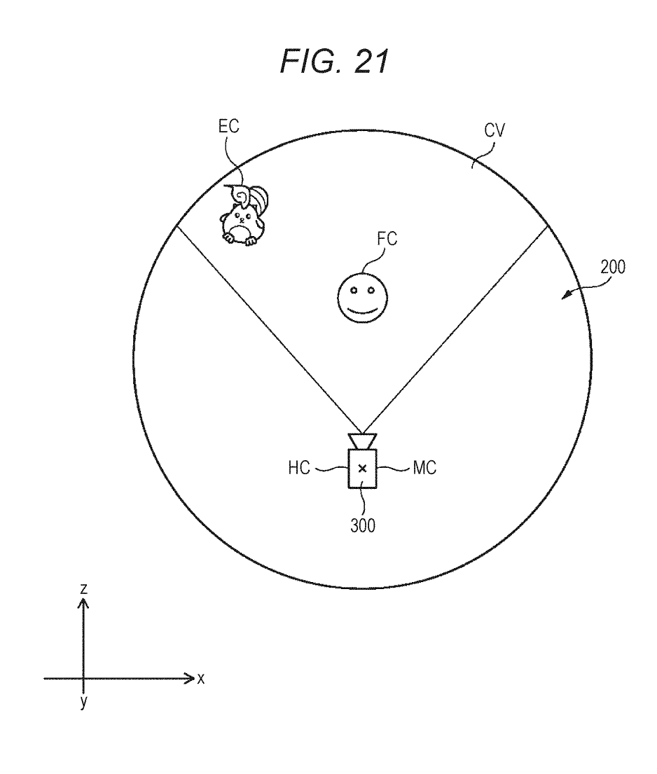

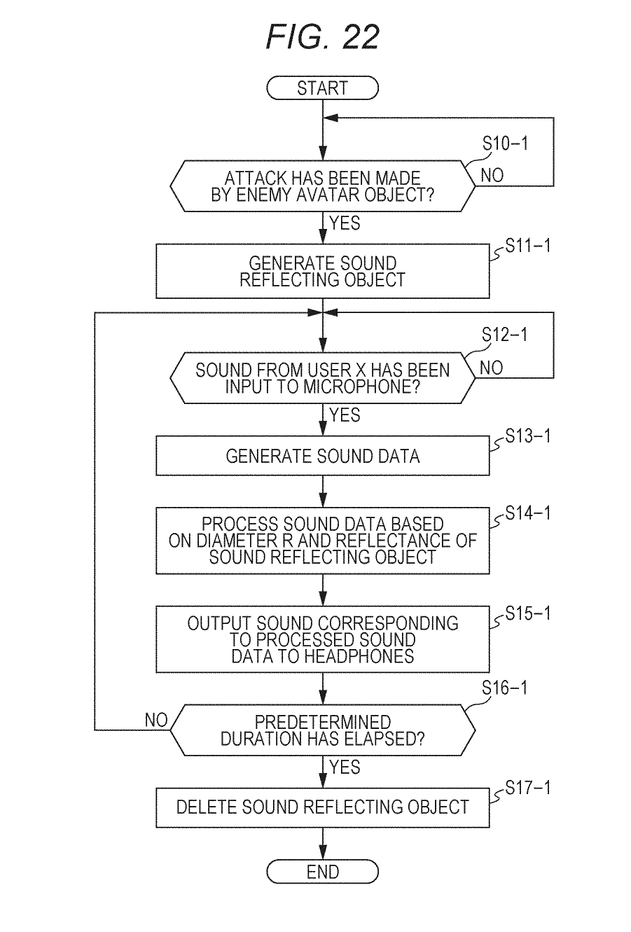

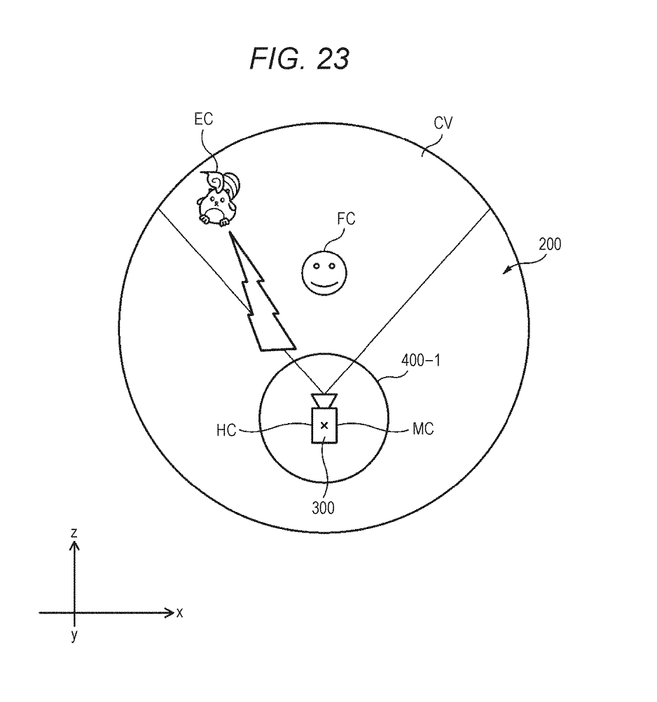

Next, an information processing method according to at least one embodiment is described with reference to FIG. 21 to FIG. 23. FIG. 21 is a diagram including the virtual space 200 exhibited before a sound reflecting object 400-1 (refer to FIG. 23) is generated according to at least one embodiment of this disclosure. FIG. 22 is a flowchart of an information processing method according to at least one embodiment of this disclosure. FIG. 23 is a diagram of the virtual space 200 including the sound reflecting object 400-1 according to at least one embodiment of this disclosure.

First, in FIG. 21, the virtual space 200 includes the virtual camera 300, the sound source object MC, the self avatar object (not shown), a sound collecting object HC, and the friend avatar object FC. The control unit 121 is configured to generate virtual space data for defining the virtual space 200 including those objects.

The virtual camera 300 is associated with the HMD system 1A operated by the user X. More specifically, the position and direction (i.e., visual field CV of virtual camera 300) of the virtual camera 300 change in accordance with the movement of the HMD 110 worn by the user X. In at least one embodiment, because the perspective of the virtual space presented to the user is a first-person perspective, the virtual camera 300 is integrally constructed with the self avatar object (not shown). However, when the perspective of the virtual space presented to the user X is a third-person perspective, the self avatar object is displayed in the visual field of the virtual camera 300.

The sound source object MC is defined as a sound source of the sound from the user X (refer to FIG. 1) input to the microphone 118, and is integrally constructed with the virtual camera 300. When the sound source object MC and the virtual camera 300 are integrally constructed, the virtual camera 300 may be construed as having a sound source function. The sound source object MC may be transparent. In such a case, the sound source object MC is not displayed on the visual-field image V. The sound source object MC may also be separated from the virtual camera 300. For example, the sound source object MC may be close to the virtual camera 300 and be configured to follow the virtual camera 300 (i.e., the sound source object MC may be configured to move in accordance with the movement of the virtual camera 300).

Similarly, the sound collecting object HC is defined as a sound collector configured to collect sounds propagating on the virtual space 200, and is integrally constructed with the virtual camera 300. When the sound collecting object HC and the virtual camera 300 are integrally constructed, the virtual camera 300 may be construed as having a sound collector function. The sound collecting object HC may be transparent. The sound collecting object HC may be separated from the virtual camera 300. For example, the sound collecting object HC may be close to the virtual camera 300 and be configured to follow the virtual camera 300 (i.e., the sound collecting object HC may be configured to move in accordance with the movement of the virtual camera 300).

The friend avatar object FC is associated with the HMD system 1B operated by the user Y. More specifically, the friend avatar object FC is the avatar object of the user Y, and is controlled based on operations performed by the user Y. The friend avatar object FC may function as a sound source of the sound from the user Y input to the microphone 118 and as a sound collector configured to collect sounds propagating on the virtual space 200. In other words, the friend avatar object FC may be integrally constructed with the sound source object and the sound collecting object.

The enemy avatar object EC is controlled through operations performed by the user Z. That is, the enemy avatar object EC is controlled through operations performed by the user Z. The enemy avatar object EC may function as a sound source of the sound from the user Z input to the microphone 118 and as a sound collector configured to collect sounds propagating on the virtual space 200.

In other words, the enemy avatar object EC may be integrally constructed with the sound source object and the sound collecting object. In at least one embodiment, there is an assumption that when the users X to Z are playing an online game that many people can join, the user X and the user Y are friends, and the user Z is an enemy of the user X and the user Y. In at least one embodiment, the enemy avatar object EC is operated by the user Z, but the enemy avatar object EC may be controlled by a computer program (i.e., central processing unit (CPU)).

Next, the information processing method according to at least one embodiment is described with reference to FIG. 22. In FIG. 22, in Step S10-1, the control unit 121 of the HMD system 1A (hereinafter simply referred to as “control unit 121”) judges whether or not the self avatar object (not shown) has been subjected to a predetermined attack from the enemy avatar object EC. When the self avatar object is judged to have been subjected to the predetermined attack from the enemy avatar object EC (YES in Step S10-1), the control unit 121 generates a sound reflecting object 400-1 (Step S11-1). On the other hand, when the self avatar object is judged to not have been subjected to the predetermined attack from the enemy avatar object EC (NO in Step S10-1), the control unit 121 returns the processing to Step S10-1. In at least one embodiment, the sound reflecting object 400-1 is generated when the self avatar object has been subjected to an attack from the enemy avatar object EC, but the sound reflecting object 400-1 may be generated when the self avatar object is subjected to a predetermined action other than an attack.

In FIG. 23, the virtual space 200 includes the sound reflecting object 400-1 in addition to the objects arranged in the virtual space 200 in FIG. 21. The sound reflecting object 400-1 is defined as a reflecting body configured to reflect sounds propagating through the virtual space 200. The sound reflecting object 400-1 is arranged so as to surround the virtual camera 300, which is integrally constructed with the sound source object MC and the sound collecting object HC. Similarly, even when the sound source object MC and the sound collecting object HC are separated from the virtual camera 300, the sound reflecting object 400-1 is arranged so as to surround the sound source object MC and the sound collecting object HC.

The sound reflecting object 400-1 has a predetermined sound reflection characteristic and sound transmission characteristic. For example, the reflectance of the sound reflecting object 400-1 is set to a predetermined value, and the transmittance of the sound reflecting object 400-1 is also set to a predetermined value. For example, when the reflectance and the transmittance of the sound reflecting object 400-1 are each 50%, and the volume (i.e., sound pressure level) of incident sound incident on the sound reflecting object 400-1 is 90 dB, the volume of the reflected sound reflected by the sound reflecting object 400-1 and the volume of the transmitted sound transmitted through the sound reflecting object 400-1 are each 87 dB.

The sound reflecting object 400-1 is formed in a spherical shape that has a diameter R and that matches a center position of the virtual camera 300, which is integrally constructed with the sound source object MC and the sound collecting object HC. More specifically, because the virtual camera 300 is arranged inside the spherically-formed sound reflecting object 400-1, the virtual camera 300 is completely surrounded by the sound reflecting object 400-1. Even when the sound source object MC and the sound collecting object HC are separated from the virtual camera 300, the center position of the sound reflecting object 400-1 matches the center position of at least one of the sound source object MC and the sound collecting object HC.

In at least one embodiment, the sound reflecting object 400-1 may be transparent. In this case, because the sound reflecting object 400-1 is not displayed on the visual-field image V, the sense of immersion of the user X in the virtual space (i.e., sense of being present in the virtual space) is maintained.

Returning to FIG. 22, after the processing of Step S10-1 has been executed, when a sound from the user X has been input to the microphone 118 (YES in Step S12-1), in Step S13-1, the microphone 118 generates sound data corresponding to the sound from the user X, and transmits the generated sound data to the control unit 121 of the control device 120. In this way, the control unit 121 acquires the sound data corresponding to the sound from the user X. On the other hand, when a sound from the user X has not been input to the microphone 118 (NO in Step S12-1), the processing returns to Step S12-1 again.

Next, in Step S14-1, the control unit 121 processes the sound data based on the diameter R and the reflectance of the sound reflecting object 400-1. In the virtual space 200, sound that is output in all directions (i.e., 360 degrees) from the sound source object MC, which is a point sound source, is singly reflected or multiply reflected by the sound reflecting object 400-1, and then collected by the sound collecting object HC. In at least one embodiment, because the center position of the sound reflecting object 400-1 matches the center position of the sound source object MC and the sound collecting object HC, the control unit 121 processes the sound data based on the characteristics (i.e., reflectance and diameter R) of the sound reflecting object 400-1. When the reflectance of the sound reflecting object 400-1 is larger, the volume of the sound data is larger. On the other hand, when the reflectance of the sound reflecting object 400-1 is smaller, the volume of the sound data is smaller. When the diameter R of the sound reflecting object 400-1 is larger, the volume of the sound data is reduced due to distance attenuation, and a time interval Δt (=t2−t1) between a time t1 at which the sound is input to the microphone 118 and a time t2 at which the sound is output to the headphones 116 increases. On the other hand, when the diameter R of the sound reflecting object 400-1 is smaller, the attenuation amount of the sound data due to distance attenuation is smaller (i.e., sound data volume is larger), and the time interval Δt decreases. Specifically, the time interval Δt is determined in accordance with the diameter R of the sound reflecting object 400-1.

Then, in Step S15-1, the control unit 121 outputs to the headphones 116 of the HMD system 1A the sound corresponding to the processed sound data. The control unit 121 outputs the sound corresponding to the processed sound data to the headphones 116 worn on both ears of the user X after a predetermined duration (e.g., after 0.2 to 0.3 seconds) has elapsed since the sound from the user X was input to the microphone 118. Because the virtual camera 300 (i.e., sound source object MC and sound collecting object HC) is completely surrounded by the spherical sound reflecting object 400-1, an acoustic echo multiply reflected in a closed space defined by the sound reflecting object 400-1 is output to the headphones 116.

Then, after a predetermined time (e.g., from several seconds to 10 seconds) has elapsed (YES in Step S16-1), the control unit 121 deletes the sound reflecting object 400-1 from the virtual space (Step S17-1). When the predetermined time has not elapsed (NO in Step S16-1), the processing returns to Step S12-1. The predetermined time defined in Step S16-1 may be longer (e.g., 1 minute). In this case, the sound reflecting object 400-1 may also be deleted when a predetermined recovery item has been used.

According to at least one embodiment, a sound (i.e., acoustic echo) corresponding to the processed sound data is output to the headphones 116 worn by the user X after a predetermined duration has elapsed since the sound from the user X was input to the microphone 118. In this way, when the user X is trying to communicate via sound with the user Y operating the friend avatar object FC arranged on the virtual space 200, the sound from the user X is output by the sound reflecting object 400-1 from the headphones 116 after the predetermined duration has elapsed. As a result, the user X is hindered from communicating with the user Y based on his or her own sound output from the headphones 116. Therefore, there can be provided an information processing method capable of improving the entertainment value of the virtual space by suitably executing communication among the users utilizing sound in the virtual space.

According to at least one embodiment, when the enemy avatar object EC has launched an attack against the self avatar object, the user X is hindered from communicating via sound with the user Y based on his or her own sound output from the microphone 118. As a result, the entertainment value of the virtual space can be improved. In particular, the sound data is processed based on the reflectance and the diameter R of the sound reflecting object 400-1 arranged in the virtual space 200, and the sound corresponding to the processed sound data is output to the headphones 116. As a result, an acoustic echo multiply reflected in a closed space by the sound reflecting object 400-1 can be output to the headphones 116.

According to at least one embodiment, the reflectance of the sound reflecting object 400-1 is set to a predetermined value, and the transmittance of the sound reflecting object 400-1 is set to a predetermined value. As a result, the user X is hindered from communicating via sound with the user Y based on his or her own sound. On the other hand, the user Y can hear sound uttered by the user X, and the user X can hear sound uttered by the user Y. In this case, the HMD system 1A is configured to transmit the sound data corresponding to the sound from the user X to the HMD system 1B via the communication network 3 and the game server 2, and the HMD system 1B is configured to transmit the sound data corresponding to the sound from the user Y to the HMD system 1A via the communication network 3 and the game server 2. As a result, the entertainment value of the virtual space can be improved. Because the user X can hear the sounds produced from other sound source objects, for example, the user Y, the sense of immersion of the user X in the virtual space is substantially maintained.

In at least one embodiment, the sound reflecting object 400-1 is generated in response to an attack from the enemy avatar object EC, and based on the characteristics of the generated sound reflecting object 400-1, after a predetermined duration has elapsed since the sound was input to the microphone 118, the sound (i.e., acoustic echo) corresponding to the processed sound data is output to the headphones 116. However, this disclosure is not limited to this. For example, in at least one embodiment, the control unit 121 may be configured to output an acoustic echo to the headphones 116 after the predetermined duration has elapsed, without generating the sound reflecting object 400-1. Specifically, when a predetermined event, for example, an attack from the enemy avatar object EC, has occurred, the control unit 121 may be configured to process the sound data based on a predetermined algorithm such that the sound from the user X is an acoustic echo, and to output the sound corresponding to the processed sound data to the headphones 116 after the predetermined duration has elapsed.

In at least one embodiment, the sound reflecting object 400-1 is described as having a spherical shape, but this embodiment is not limited to this. The sound reflecting object may have a columnar shape or a cuboid shape. The shape of the sound reflecting object is not particularly limited, as long as the virtual camera 300 integrally constructed with the sound source object MC and the sound collecting object HC is surrounded by the sound reflecting object.

Further, in order to achieve various types of processing to be executed by the control unit 121 with use of software, instructions for executing an image processing method of at least one embodiment on a computer (processor) may be installed in advance into the storage unit 123 or the ROM. Alternatively, the instructions may be stored in a computer-readable storage medium, for example, a magnetic disk (HDD or floppy disk), an optical disc (for example, CD-ROM, DVD-ROM, or Blu-ray disc), a magneto-optical disk (for example, MO), and a flash memory (for example, SD card, USB memory, or SSD). In this case, the storage medium is connected to the control device 120, and thus the program stored in the storage medium is installed into the storage unit 123. Then, the instructions are installed in the storage unit 123 is loaded onto the RAM, and the processor executes the loaded program. In this manner, the control unit 121 executes the image processing method of at least one embodiment.

Further, the instructions may be downloaded from a computer on the communication network 3 via the communication interface 125. Also in this case, the downloaded program is similarly installed into the storage unit 123.

The above description includes:

(1) An information processing method for use in a system including a user terminal including a head-mounted display, a sound inputting unit, and a sound outputting unit. The information processing method includes generating virtual space data for representing a virtual space including a virtual camera, a sound source object for producing a sound to be input to the sound inputting unit, and a sound collecting object. The method further includes determining a visual field of the virtual camera in accordance with a movement of the head-mounted display. The method further includes generating visual-field image data based on the visual field of the virtual camera and the virtual space data. The method further includes causing the head-mounted display to display a visual-field image based on the visual-field image data. The method further includes acquiring sound data representing a sound that has been input to the sound inputting unit. The method further includes processing the sound data. The method further includes causing the sound outputting unit to output, after a predetermined duration has elapsed since input of the sound to the sound inputting unit, a sound corresponding to the processed sound data.

According to the above-mentioned method, the sound corresponding to the processed sound data is output to the sound outputting unit after the predetermined duration has elapsed since input of the sound to the sound inputting unit. In this way, for example, when the user of the user terminal (hereinafter simply referred to as “first user”) is trying to communicate via sound with a user (hereinafter simply referred to as “second user”) operating a friend avatar object arranged on the virtual space, the sound from the first user is output from the sound outputting unit after the predetermined duration has elapsed. As a result, the first user is hindered from communicating via sound with the second user due to his or her own sound output from the sound outputting unit. Therefore, there can be provided an information processing method capable of improving the entertainment value of the virtual space by suitably executing communication between the users utilizing sound in the virtual space.

(2) An information processing method according to Item (1), in which the virtual space further includes an enemy object. The method further includes judging whether or not the enemy object has carried out a predetermined action on an avatar object associated with the user terminal. The processing of the sound data and the causing of the sound outputting unit to output the sound is performed in response to a judgement that the enemy object has carried out the predetermined action on the avatar object.

According to the above-mentioned method, when the enemy object has carried out the predetermined action on the avatar object, after a predetermined duration has elapsed since the sound data was processed and the sound was input to the sound inputting unit, the sound corresponding to the processed sound data is output to the sound outputting unit. In this way, for example, when the enemy object has carried out the predetermined action on the avatar object (e.g., when the enemy object has launched an attack against the avatar object), the first user is hindered from communicating via sound with the second user due to his or her own sound output from the sound outputting unit. Therefore, there can be provided an information processing method capable of improving the entertainment value of the virtual space by suitably executing communication between the users utilizing sound in the virtual space.

(3) An information processing method according to Item (1) or (2), in which the virtual space further includes a sound reflecting object that is defined as a sound reflecting body configured to reflect sounds propagating through the virtual space. The sound reflecting body is arranged in the virtual space so as to surround the virtual camera. The sound data is processed based on a characteristic of the sound reflecting object.

According to the above-mentioned method, the sound data is processed based on the characteristic of the sound reflecting object arranged in the virtual space, and the sound corresponding to the processed sound data is output to the sound outputting unit.

Therefore, an acoustic echo multiply reflected in a closed space defined by the sound reflecting object can be output to the sound outputting unit.

(4) An information processing method according to Item (3), in which a reflectance of the sound reflecting object is set to a first value, and a transmittance of the sound reflecting object is set to a second value.

According to the above-mentioned method, the reflectance of the sound reflecting object is set to the first value, and the transmittance of the sound reflecting object is set to the second value. Therefore, the first user is hindered from communicating via sound with the second user due to his or her own sound. On the other hand, the second user can hear sound uttered by the first user, and the first user can hear sound uttered by the second user. As a result, the entertainment value of the virtual space can be improved. Further, because the first user can hear sound produced by other sound source objects, the sense of immersion of the first user in the virtual space (i.e., sense of being present in the virtual space) is prevented from being excessively harmed.

(5) An information processing method according to Item (4), in which a center position of the sound reflecting object matches a center position of the virtual camera. The sound reflecting object is formed in a spherical shape having a predetermined diameter. The sound data is processed based on the reflectance of the sound reflecting object and the diameter of the sound reflecting object.

According to the above-mentioned method, the sound data is processed based on the reflectance of the sound reflecting object and the diameter of the sound reflecting object, and the sound corresponding to the processed sound data is output to the sound outputting unit. Therefore, an acoustic echo multiply reflected in a closed space defined by the sound reflecting object can be output to the sound outputting unit.

(6) An information processing method according to any one of Items (3) to (5), in which the sound reflecting object is transparent or inhibited from being displayed in the visual-field image.

According to the above-mentioned method, because the sound reflecting object is not displayed in the visual-field image, the sense of immersion of the first user in the virtual space (i.e., sense of being present in the virtual space) is maintained.

(7) A system for executing the information processing method of any one of Items (1) to (6).

According to the above-mentioned method, there can be provided a program that is capable of improving the entertainment value of the virtual space by suitably executing communication between the users utilizing sound in the virtual space.

This concludes description of embodiments of this disclosure. However, the description of the embodiments is not to be read as a restrictive interpretation of the technical scope of this disclosure. The embodiments are merely given as an example, and it is to be understood by a person skilled in the art that various modifications can be made to the embodiment within the scope of this disclosure set forth in the appended claims. Thus, the technical scope of this disclosure is to be defined based on the scope of this disclosure set forth in the appended claims and an equivalent scope thereof.

1-14. (canceled)

15. An information processing method for use in a system comprising a first user terminal comprising a first head-mounted display (HMD) and a sound inputting unit, the information processing method comprising:
generating virtual space data for defining a virtual space comprising a virtual camera and a sound source object, wherein the virtual space includes a first region and a second region, and the second region is different from the first region;
determining a visual field of the virtual camera in accordance with a detected movement of the first HMD;
generating visual-field image data based on the visual field of the virtual camera and the virtual space data;
instructing the first HMD to display a visual-field image based on the visual-field image data;
setting an attenuation coefficient for defining an attenuation amount of a sound propagating through the virtual space, wherein the attenuation coefficient is set based on a the visual field of the virtual camera; and
processing the sound based on the attenuation coefficient.

16. The information processing method according to claim 15, wherein the system further comprises a second user terminal comprising a second HMD and a sound outputting unit, wherein generating the virtual space data comprises defining a second avatar object associated with the second user terminal, and
the information processing method further comprises:
acquiring sound data, corresponding to the sound, from the sound inputting unit;
specifying a relative positional relationship between the sound source object and the second avatar object;
processing the sound data based on the specified relative positional relationship and the attenuation coefficient; and
instructing the sound outputting unit to output an output sound corresponding to the processed sound data,
wherein in response to the second avatar object being positioned in the first region of the virtual space, the attenuation coefficient is set to a first attenuation coefficient, and
wherein in response to the second avatar object being positioned in the second region of the virtual space, different from the first region, the attenuation coefficient is set to a second attenuation coefficient different from the first attenuation coefficient.

17. The information processing method according to claim 15,
wherein the first region is in the visual field of the virtual camera, and the second region is outside the visual field of the virtual camera.

18. The information processing method according to claim 15,
wherein the first region is an eye gaze region defined by a detected line-of-sight direction of a user wearing the first HMD, and the second region is in the visual field of the virtual camera and outside the eye gaze region.

19. The information processing method according to claim 15,
wherein the first region is a visual axis region defined by a visual axis of the virtual camera, and the second region is in the visual field of the virtual camera other than the visual axis region.

20. The information processing method according to claim 15,
wherein defining the virtual space comprises defining the virtual space further comprising an attenuation object for defining an additional attenuation amount, the attenuation object is arranged between the first region and the second region, and the second attenuation coefficient is set based on the first attenuation coefficient and the additional attenuation amount.

21. The information processing method according to claim 20, wherein the attenuation object is inhibited from being displayed in the visual-field image.

22. The information processing method according to claim 20, wherein the sound source object is in the first region.

23. The information processing method according to claim 15, wherein the first user terminal further comprises a sound outputting unit, and
the information processing method further comprises causing the sound outputting unit to output the processed sound after a predetermined duration has elapsed since receipt of the sound by the sound inputting unit.

24. The information processing method according to claim 23, wherein defining the virtual space comprises defining the virtual space further comprising an enemy object, and
the information processing method further comprises instructing the sound outputting unit to output the processed sound in response to a determination that the enemy object has carried out a predetermined action on a first avatar object associated with the first user terminal.

25. The information processing method according to claim 23, wherein defining the virtual space comprises defining the virtual space further comprising a sound collecting object and a sound reflecting object, the sound reflecting object is between the first region of the virtual space and the second region of the virtual space,
the sound reflecting object surrounds the sound source object and the sound collecting object,
the sound collecting object is configured to collect via the sound reflecting object the sound that has been output from the sound source object,
the sound is processed based on the attenuation coefficient and a relative positional relationship among the sound source object, the sound collecting object, and the sound reflecting object, and
the sound outputting unit is instructed to output the processed sound.

26. The information processing method according to claim 25,
wherein the first region is on a first side of the sound reflecting object closer to the virtual camera, and the second region is on a second side of the sound reflecting object opposite the first side.

27. The information processing method according to claim 15, wherein setting the attenuation coefficient comprises:
setting the attenuation coefficient to a first attenuation coefficient in response to a second avatar object being positioned in the first region of the virtual space;
setting the attenuation coefficient to a second attenuation coefficient, different from the first attenuation coefficient, in response to the second avatar object being positioned in the second region of the virtual space; and
setting the attenuation coefficient to a third attenuation coefficient, different from the first attenuation coefficient and the second attenuation coefficient, in response to the second avatar object being positioned in a third region of the virtual space different from both the first region and the second region.

28. The information processing method of claim 27, wherein the first region is along a detected visual axis of a user of the first user terminal.

29. The information processing method of claim 28, wherein the second region is within the visual field.

30. The information processing method of claim 29, wherein the third region is outside the visual field.

31. A system for executing an information processing method, the system comprising:
a first user terminal comprising a first head-mounted display (HMD), a first processor and a first memory; and
a server connected to the first user terminal, wherein the server comprises a second processor and a second memory, wherein at least one of the first processor or the second processor is configured to:
generate virtual space data for defining a virtual space comprising a virtual camera and a sound source object, wherein the virtual space includes a first region and a second region, and the second region is different from the first region;
determine a visual field of the virtual camera in accordance with a detected movement of the first HMD;
generate visual-field image data based on the visual field of the virtual camera and the virtual space data;
instruct the first HMD to display a visual-field image based on the visual-field image data;
set an attenuation coefficient for defining an attenuation amount of a sound propagating through the virtual space, wherein the attenuation coefficient is set based on a the visual field of the virtual camera; and
process the sound based on the attenuation coefficient.

32. The system of claim 31, further comprising a second user terminal comprising a second HMD, wherein the second HMD comprises a sound outputting unit, and the second processor is configured to transmit the processed sound to the second HMD.

33. The system of claim 31, wherein the first processor is configured to process the sound.

34. The system of claim 31, wherein the second processor is configured to process the sound.
